(19) United States
(12) Patent Application Publication
(10) Pub. No.: US 2026/0268424 A1
(43) Pub. Date: Sep. 10, 2026

(54) Concurrent Multi-Pipeline Voice Processing System with Lock-Free Shared State for Real-Time Lead Qualification and Autonomous Multi-Channel Communication Orchestration

(71) Applicant: Robert Underwood, Brentwood, TN (US)

(72) Inventor: Robert Underwood, Brentwood, TN (US)

(21) Appl. No.: 19/559,777

(22) Filed: Mar. 6, 2026

Related U.S. Application Data
(60) Provisional application No. 63/768,055, filed on Mar. 6, 2025.

(51) Int. Cl. G06Q 50/163; G06Q 30/02; G06Q 30/0201

(52) U.S. Cl. CPC G06Q 50/163; G06Q 30/0206; G06Q 30/0278

(57) ABSTRACT

The present disclosure provides a method of facilitating controlled remote property access authorization through a software-as-a-service real estate transaction platform. Further, the method may include receiving a property listing data associated with a property from a seller device. Further, the method may include receiving a buyer verification data comprising an identity verification parameter from a buyer device. Further, the method may include storing each of the property listing data and the buyer verification data. Further, the method may include analyzing the buyer verification data to determine a buyer verification status. Further, the method may include generating a showing authorization data representing a verified access authorization for the property based on the property listing data and the buyer verification status. Further, the method may include storing the showing authorization data. Further, the method may include transmitting the showing authorization data to the seller device.

### FIELD OF DISCLOSURE

The present disclosure generally relates to data processing. More specifically, the present disclosure relates to methods and systems of facilitating controlled remote property access authorization through a software-as-a-service real estate transaction platform.

### BACKGROUND

The present disclosure generally relates to the field of digital real estate transaction platforms and network-based property management technologies. More particularly, the present disclosure relates to computer-implemented systems and methods that facilitate coordination of property listing activities, buyer interactions, property access management, transaction processing, and related real estate workflow operations through interconnected communication networks and server-based computing infrastructure. The real estate transaction environment represents an important technological domain because it involves coordination among multiple participants, secure exchange of transaction-related data, management of property access events, and integration of numerous operational processes that occur across distributed digital systems. As residential property transactions increasingly rely on networked computing platforms and digital services, efficient technological infrastructure for coordinating such activities has become increasingly significant.

In this field, it is desirable to achieve an improved mechanism for facilitating secure and coordinated digital management of real estate transactions in a manner that supports remote participation, improves transaction transparency, enhances operational efficiency, and provides reliable data processing across multiple transaction stages. Such an objective may involve enabling coordinated communication between transaction participants, managing property access authorization in a secure manner, maintaining transaction data consistency across distributed components, and supporting efficient processing of property-related information and transaction events. Achieving these objectives may also require improvements in the manner in which transaction data is received, processed, stored, and transmitted through server-based platforms operating across communication networks.

However, existing digital platforms and transaction coordination systems may encounter several challenges when attempting to support these objectives. For example, current systems may rely on fragmented processes in which different stages of a real estate transaction are handled by separate systems that do not maintain a unified data processing environment. This fragmentation may result in inconsistent transaction records, redundant data handling, and reduced operational efficiency when information must be manually transferred between systems. In addition, property access coordination may often rely on manual scheduling mechanisms or loosely controlled authorization processes that may introduce delays, increase the possibility of unauthorized access, or complicate the monitoring of property visitation events.

Further, existing transaction management approaches may lack integrated mechanisms for coordinating verification processes, transaction data analysis, and property-related event management within a single computing environment. As a result, transaction participants may experience delays in verifying information, inconsistencies in the handling of transaction records, and limited visibility into the progress of transaction activities. Systems that attempt to manage property-related data and transaction workflows may also face difficulties in maintaining secure processing of sensitive information while simultaneously supporting remote access and distributed participation through network-based communication devices.

Additionally, known digital transaction environments may face technical challenges associated with managing large volumes of property-related data, coordinating multiple data sources, and ensuring that transaction-related information is processed in a reliable and synchronized manner across different operational stages. These challenges may affect system scalability, transaction transparency, and the ability of participants to effectively interact with digital platforms for managing property listings, transaction negotiations, and closing procedures. Limitations in monitoring property access events, coordinating inspection and valuation information, and maintaining secure transaction records may further complicate the digital management of property transactions.

Consequently, the technological landscape associated with digital real estate transaction platforms continues to present challenges related to secure property access coordination, integrated transaction data processing, efficient workflow management, and reliable communication between distributed participants and computing systems. These challenges highlight the need for improved technological solutions capable of facilitating coordinated real estate transaction activities through network-based computing infrastructure.

Therefore, there is a need for improved methods and systems for facilitating secure and coordinated digital management of real estate transactions that can overcome one or more of the preceding problems.

### SUMMARY OF DISCLOSURE

This summary is provided to introduce selected concepts in a simplified form. The concepts are further described in the Detailed Description. The summary is not intended to identify essential features of the claimed subject matter, nor is it intended to limit the scope of the claims.

The present disclosure provides a method of facilitating controlled remote property access authorization through a software-as-a-service real estate transaction platform. Further, the method may include receiving, using a communication device, a property listing data associated with a property from a seller device. Further, the method may include receiving, using the communication device, a buyer verification data comprising an identity verification parameter from a buyer device. Further, the method may include storing, using a storage device, each of the property listing data and the buyer verification data. Further, the method may include analyzing, using a processing device, the buyer verification data to determine a buyer verification status. Further, the method may include generating, using the processing device, a showing authorization data representing a verified access authorization for the property based on the property listing data and the buyer verification status. Further, the method may include storing, using the storage device, the showing authorization data. Further, the method may include transmitting, using the communication device, the showing authorization data to the seller device.

The present disclosure provides a system for facilitating controlled remote property access authorization through a software-as-a-service real estate transaction platform. Further, the system may include a communication device. Further, the communication device may be configured for receiving a property listing data associated with a property from a seller device. Further, the communication device may be configured for receiving a buyer verification data comprising an identity verification parameter from a buyer device. Further, the communication device may be configured for transmitting a showing authorization data to the seller device. Further, the system may include a processing device. Further, the processing device may be configured for analyzing the buyer verification data to determine a buyer verification status. Further, the processing device may be configured for generating the showing authorization data representing a verified access authorization for the property based on the property listing data and the buyer verification status. Further, the system may include a storage device which may be configured for storing each of the property listing data, the buyer verification data and the showing authorization data.

Both the foregoing summary and the following description provide illustrative examples and are not limiting. Features described in connection with one embodiment may be combined with features of another embodiment unless stated otherwise or unless such combination would be incompatible.

### BRIEF DESCRIPTIONS OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure.

The drawings presented with this disclosure may illustrate representative and non-limiting arrangements of hardware components, software modules, artificial intelligence subsystems, machine learning architectures, data processing pipelines, user interfaces, network topologies, and memory arrangements that may be used to understand embodiments of the present subject matter. They may depict functional or conceptual layouts intended to facilitate explanation of the disclosed principles. The geometric appearance, dimensional proportions, ordering, grouping, and naming of elements within the drawings are not intended to imply any restriction on implementation. The drawings may schematically portray computing environments containing client devices, servers, distributed computing clusters, communication networks, storage systems, or artificial intelligence models arranged for training, inference, or combined operations. The drawings may include simplified symbolic representations of algorithmic processes, workflows, blocks, or modules; such symbolic representations are treated as abstractions of underlying hardware and software operations rather than literal structural requirements. Similarly, lines connecting components may represent logical associations, communication pathways, or data relationships rather than any specific physical wiring or layout. These figures may also illustrate non-exhaustive examples of operational stages, sequencing, or interactions among artificial intelligence components such as encoders, decoders, generators, discriminators, featurizers, transformers, or safety-validation modules. Any specific combination or configuration shown is presented for explanatory clarity only. Additional drawings, alternative views, or more granular depictions may be used without affecting the scope of the claims.

FIG. 1 is an illustration of an online platform 100 consistent with various embodiments of the present disclosure.

FIG. 2 is a block diagram of a computing device 200 for implementing the methods disclosed herein, in accordance with some embodiments.

FIG. 3 is a block diagram of a machine-learning system 300 for implementing various embodiments of this disclosure, in accordance with some embodiments.

FIG. 4A illustrates a flowchart of a method 400 of facilitating controlled remote property access authorization through a software-as-a-service real estate transaction platform, in accordance with some embodiments.

FIG. 4B illustrates a continuation of the flowchart of the method 400 of facilitating controlled remote property access authorization through a software-as-a-service real estate transaction platform, in accordance with some embodiments.

FIG. 5 illustrates a flowchart of a method 500 of facilitating controlled remote property access authorization through a software-as-a-service real estate transaction platform including generating, using the processing device 1404, a demonstration guidance data, in accordance with some embodiments.

FIG. 6 illustrates a flowchart of a method 600 of facilitating controlled remote property access authorization through a software-as-a-service real estate transaction platform including generating, using the processing device 1404, a monitoring event data, in accordance with some embodiments.

FIG. 7 illustrates a flowchart of a method 700 of facilitating controlled remote property access authorization through a software-as-a-service real estate transaction platform including generating, using the processing device 1404, a showing schedule data, in accordance with some embodiments.

FIG. 8 illustrates a flowchart of a method 800 of facilitating controlled remote property access authorization through a software-as-a-service real estate transaction platform including determining, using the processing device 1404, a background verification status, in accordance with some embodiments.

FIG. 9 illustrates a flowchart of a method 900 of facilitating controlled remote property access authorization through a software-as-a-service real estate transaction platform including generating, using the processing device 1404, a contract preparation data, in accordance with some embodiments.

FIG. 10 illustrates a flowchart of a method 1000 of facilitating controlled remote property access authorization through a software-as-a-service real estate transaction platform including generating, using the processing device 1404, an inspection assessment data, in accordance with some embodiments.

FIG. 11 illustrates a flowchart of a method 1100 of facilitating controlled remote property access authorization through a software-as-a-service real estate transaction platform including computing, using the processing device 1404, a valuation comparison data between the market valuation parameter and the property listing data, in accordance with some embodiments.

FIG. 12 illustrates a flowchart of a method 1200 of facilitating controlled remote property access authorization through a software-as-a-service real estate transaction platform including generating, using the processing device 1404, a closing authorization data, in accordance with some embodiments.

FIG. 13 illustrates a flowchart of a method 1300 of facilitating controlled remote property access authorization through a software-as-a-service real estate transaction platform including processing, using the processing device 1404, the property imaging data to generate a virtual tour data, in accordance with some embodiments.

FIG. 14 illustrates a block diagram of a system 1400 of facilitating controlled remote property access authorization through a software-as-a-service real estate transaction platform, in accordance with some embodiments.

FIG. 15 illustrates an exemplary workflow diagram representing a transaction process implemented by a real estate transaction platform, according to some embodiments.

### DETAILED DESCRIPTION OF DISCLOSURE

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein—as understood by the ordinary artisan based on the contextual use of such term—differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of the disclosed use cases, embodiments of the present disclosure are not limited to use only in this context.

The detailed description that follows may provide a framework for describing computer-implemented systems, artificial intelligence systems, distributed learning infrastructures, data processing pipelines, and hardware and software arrangements suitable for implementing embodiments shown in the drawings. Terms such as processing, computing, determining, or generating refer to actions performed by computing systems or electronic devices that manipulate data represented as physical signals, stored values, or encoded information within registers, memory structures, and storage devices.

The present disclosure contemplates implementations involving artificial intelligence, machine learning, distributed computation, and computer-implemented systems operating upon data represented as physical electronic or optical signals. Descriptions of processing, analyzing, determining, transforming, encoding, decoding, generating, inferring, synthesizing, modifying, storing, retrieving, ranking, filtering, validating, classifying, or otherwise manipulating information are to be understood as referring to the actions of computing systems, electronic devices, or computational circuits that manipulate such signals in memory elements, registers, buffers, or storage media. These operations may be performed by general-purpose processors, specialized processors, machine learning accelerators, or combinations thereof.

The disclosure contemplates implementations in which artificial intelligence systems perform perception, synthesis, inference, prediction, or generation of information using models whose configurations may evolve based on training, feedback, or adaptive learning processes. A model may initially be configured with a set of parameters and architectural structures that define its behavior, and this configuration may change automatically as the model encounters training inputs, validation data, reference data, or instructor-provided feedback. A machine learning model may modify its internal state through optimization techniques, gradient updates, reinforcement signals, vector transformations, attention mechanisms, latent variable adjustments, embedding refinements, or other learning operations executed electronically. Such modifications may occur over extended cycles, partial cycles, or continual learning sequences without explicit intervention by a human.

The disclosure contemplates systems involving data ingestion pipelines that gather input from sources including but not limited to sensor signals, event streams, text data, image data, audio data, video data, structured and unstructured repositories, application logs, telemetric feeds, network services, or human-generated content. Ingestion functions may include filtering, normalization, augmentation, segmentation, batching, tokenization, windowing, compression, encryption, decryption, hashing, deduplication, contextualization, and mapping to internal formats. Intermediate components may transform this data into derived representations, including embeddings, latent encodings, feature tensors, multi-modal joint representations, or contextual vectors suitable for use by downstream modeling engines. These transformations may be performed using neural networks, statistical encoders, dimensionality-reduction algorithms, or hybrid computational modules.

The disclosure contemplates machine learning systems that may employ advanced architectures such as transformer networks, encoder-decoder stacks, mixture-of-experts structures, diffusion models, recurrent networks, convolutional hierarchies, attention-based models, retrieval-augmented architectures, cross-modal alignment engines, graph neural networks, probabilistic models, auto-encoding frameworks, or hybrid symbolic-neural systems. Such models may implement deep layers configured to perform operations including attention calculations, feed-forward projections, gating operations, positional encoding, normalization steps, multi-head routing, sequential decoding, or latent pathway selection. Multi-modal systems may combine textual, visual, auditory, sensory, or structured inputs within joint representational spaces. Embeddings may be learned from large corpora or multi-modal datasets and may encode semantic, syntactic, structural, temporal, spatial, or contextual relationships across modalities. These embeddings may be dynamically updated as the system encounters new information, thereby improving consistency, expressiveness, or alignment with real-world contexts.

The disclosure contemplates training processes that may involve supervised learning, unsupervised learning, semi-supervised learning, self-supervised learning, reinforcement learning, preference optimization, curriculum-based learning, active learning, or continual learning. Training operations may include forward passes through the model, backward propagation of gradients, update steps using optimization algorithms, adaptive learning-rate scheduling, regularization steps, loss-function evaluation, and checkpointing of intermediate states. Training datasets may include real-world data, synthetic data, simulated data, augmented data, or mixtures thereof. Validation procedures may evaluate performance metrics, generalization behavior, safety constraints, or compliance with domain-specific criteria. In some implementations, refinement cycles may incorporate human-in-the-loop interventions, reward model shaping, safety evaluator feedback, or guided corrections.

The disclosure contemplates distributed or federated execution in which computation is partitioned across multiple hardware devices, regions, or clusters. Certain operations may occur at edge devices for low latency, while others may be delegated to remote servers, cloud clusters, datacenters, or specialized compute fabrics. Components may communicate over wired or wireless networks supporting data exchange, synchronization, replication, or model-state updates. Distributed learning processes may synchronize gradients, coordinate model versions, merge updates across shards, or exchange activation values within parallel training regimes. Distributed inference may involve routing requests across replicas, balancing load through orchestration layers, or selecting model pathways dynamically. Network connections may include encryption, authentication, secure session management, or routing protocols appropriate for maintaining privacy, integrity, or availability.

The disclosure contemplates orchestration layers capable of managing complex workflows involving model invocation, tool invocation, external data retrieval, decision routing, fallback selection, multi-model aggregation, post-processing evaluation, or safety governance. Orchestration environments may evaluate contextual signals, metadata, user characteristics, or policy constraints to determine which models, subsystems, or computational branches should be executed. Such environments may dynamically alter execution pathways based on estimated performance, resource availability, model confidence, safety risk, or real-time system health. Post-processing components may evaluate generated outputs for compliance with content policies, statutory requirements, operational constraints, or domain-specific decision rules.

The disclosure contemplates safety-oriented components that evaluate model outputs or intermediate representations for consistency with safety criteria, quality thresholds, regulatory considerations, factual accuracy constraints, domain restrictions, or alignment requirements. Safety modules may employ auxiliary models, discriminators, rule sets, statistical detectors, confidence estimators, or hybrid evaluators to identify undesirable outputs. These modules may trigger remediation actions including output modification, output rejection, re-routing through alternate inference pathways, invocation of corrective models, or escalation for human review. Safety processes may incorporate real-time validation, contextual scoring, adversarial robustness analysis, anomaly detection, or controlled generation constraints.

The disclosure contemplates governance structures including policy managers, audit loggers, compliance trackers, version controllers, and provenance systems that associate model outputs with contextual metadata, historical signals, update events, training sources, or safety evaluations. Systems may maintain lineage records documenting which model version, configuration state, or training dataset contributed to an outcome. Governance modules may ensure that system behavior aligns with formal requirements such as fairness principles, legal obligations, industry standards, or institutional guidelines.

The disclosure contemplates storage and memory systems capable of storing model parameters, datasets, embeddings, logs, metrics, checkpoints, execution traces, and auxiliary information used to configure or interpret model behavior. These storage systems may include magnetic media, semiconductor memory, optical media, solid-state arrays, distributed storage fabrics, or hybrid memory hierarchies. Storage media may contain instructions, configurations, or data structures that, when accessed by a computing device, configure that device to carry out the operations described herein. Such media may include executables, bytecode, machine code, firmware, microcode, program modules, configuration files, architectural descriptors, or schema definitions.

The disclosure contemplates user interfaces that permit human operators to view model outputs, initiate tasks, modify configurations, inspect metrics, interact with logs, evaluate safety signals, or guide system adaptation. Interfaces may be multimodal and may support textual input, speech commands, visual interaction, gesture control, or programmatic invocation through APIs. Administrative interfaces may allow for reviewing system performance, tuning operational thresholds, enabling or disabling features, monitoring resource use, examining generated content, or initiating refinement workflows.

The disclosure contemplates systems in which instructions are executed entirely on a single device, partially on multiple devices, or cooperatively across remote and local environments. Code may execute directly on hardware, within firmware, inside virtual machines, inside containers, or through any combination of software and hardware interactions. Computational instructions may be stored locally, transferred via communication networks, or streamed from remote systems. Implementations may involve software executing on general-purpose processors, specialized logic circuits performing equivalent functions, or hybrid mechanisms that combine hardware acceleration with software guidance.

Interpretation of terms in this disclosure is governed by principles commonly applied by persons of ordinary skill in the relevant field. Technical and scientific terms used herein should be understood in a manner consistent with their usage in the field of artificial intelligence, machine learning, computing, networking, data storage, or any related discipline. Terms describing functionality should not be interpreted as strictly structural unless explicitly stated. Phrases such as configured to, adapted to, operable to, or capable of indicate permissible functionality rather than structural limitations. Terms such as a or an encompass one or more unless clearly contradicted by context. Terms joined by or should be interpreted as inclusive, and terms joined by and should be interpreted as collective.

The description set forth herein provides a broad and flexible framework intended to support a wide range of computer-implemented, machine-learning-enabled, distributed, and multimodal embodiments. Variations may include reallocation of tasks, substitution of algorithms, reconfiguration of models, changes to pipeline ordering, or adoption of alternate hardware. No combination or arrangement mentioned herein should be regarded as required unless explicitly stated. The scope of protection is established by the claims, interpreted in light of this description.

The present disclosure contemplates implementations that employ advanced mathematical frameworks characteristic of modern artificial intelligence systems. Machine learning models may be conceptualized as parameterized functions that map elements of an input space to elements of an output space. Such a function may be defined over real-valued, complex-valued, vector-valued, tensor-valued, or mixed-modal domains. The model may implement successive transformations applied to an ordered set of input vectors using compositions of linear operators, nonlinear activations, attention functions, normalization operations, and dimensional projections.

Model parameters may be represented as ordered collections of real-valued scalars arranged into structures such as matrices, tensors, kernels, filters, or embeddings. These parameters may be optimized by minimizing a loss functional defined over an expected distribution of input-output pairs. The optimization process may involve computing gradients of the loss functional with respect to each model parameter, followed by an update step that serves to reduce the value of the loss functional. Gradient computation may use automatic differentiation frameworks that symbolically or numerically propagate partial derivatives backward through a computational graph.

Attention mechanisms may employ a similarity measure between projected query vectors and projected key vectors. This similarity measure may yield a weight distribution over contextual elements. The weighted combination of projected value vectors may form an attention output that is subsequently transformed through additional layers. Multiple independent attention heads may be aggregated to capture heterogeneous relationships within the input domain. Cross-attention mechanisms may operate similarly but with distinct source and target sequences.

Normalization steps may rescale intermediate representations using learned scaling and shifting coefficients. Activation functions may introduce nonlinearity by applying element-wise transformations selected to ensure differentiability and expressive capacity. Residual pathways may combine transformed and untransformed representations to facilitate stable gradient propagation under deep compositions. Positional encodings or structural embeddings may inject ordering, spatial, temporal, or relational information into otherwise permutation-invariant architectures.

Multi-modal models may operate over domains that combine text, image, audio, video, sensor, or structured signals. These domains may be embedded into a common vector space through learned projection operators. Joint training processes may enforce alignment constraints that minimize representational divergence between modalities while preserving intra-modal semantics.

Diffusion frameworks may model data generation as the reversal of a stochastic corruption process. A forward process may incrementally add noise to data samples, while a learned reverse process may approximate the time-reversed conditional probability distribution. The reverse process may be parameterized by a neural network trained to denoise intermediate states. Continuous-time formulations may model this process using stochastic differential equations whose drift and diffusion terms are learned through score-matching or related techniques.

Reinforcement-based procedures may model learning as an optimization of expected reward under a policy function. The policy may produce distributions over actions given a latent or explicit representation of the environment state. Policy gradients may be estimated from sampled trajectories, and advantage estimators may reduce variance of such gradients. Value functions may approximate the expected cumulative reward, and these approximations may be updated through temporal-difference learning.

Generative models may be expressed in probabilistic terms as joint or conditional distributions parameterized by neural architectures. Such models may perform sampling by iteratively drawing latent variables from a learned distribution and transforming those variables into output space. Variational models may introduce auxiliary latent variables whose posterior distributions are approximated through recognition functions that optimize an evidence-bound objective.

Matrix decompositions, spectral analysis, manifold learning, kernel operators, and other mathematical constructs may be incorporated to improve expressiveness, stability, or computational efficiency. Training may involve sophisticated schedulers, trust-region constraints, adaptive learning-rate schemes, gradient-norm clipping, regularization penalties, entropy maximization, attention masking, or mixed-precision arithmetic.

All such mathematical constructs are conceptual, descriptive, and non-limiting. The disclosure encompasses any differentiable or non-differentiable optimization method, any discrete or continuous learning paradigm, and any representational transformation that may be understood by a person of ordinary skill in the field.

Further, the disclosure provides a computing environment which may include a combination of client devices, servers, distributed computing clusters, databases, external data sources, network nodes, and interface endpoints. Such an environment may support artificial intelligence workloads including perception, synthesis, inference, prediction, and generation, using hardware and software foundations designed for high-throughput and low-latency operation. Embodiments may involve the coordinated use of multiple machine learning models, whose configurations may evolve over time as they learn from training, validation, reference, or feedback data. Models may adjust their internal parameters through supervised, unsupervised, or reinforcement-based processes, allowing automatic electronic improvements to their performance based on input data and observed outcomes.

Further, the disclosure provides a computing device which may include processing units, memory elements, storage devices, system buses, high-speed controllers, low-speed controllers, and expansion interfaces. Processors may include general-purpose units, multi-core processors, vector processors, digital signal processors, tensor accelerators, neural accelerators, graphics engines, or various kinds of specialized integrated circuits including FPGAs, ASICs, ASSPs, SoCs, and CPLDs. A device may include system memory composed of volatile or non-volatile components such as RAM, DRAM, flash memory, ROM, or phase-change memory. The storage subsystem may include solid-state drives, magnetic disks, optical media, arrays of storage devices, and network-attached storage resources. Input and output mechanisms may include microphones, displays, keyboards, pointing devices, biometric sensors, gesture or touch interfaces, and actuators suitable for multimodal interaction with a user.

Further, the disclosure provides a machine-learning architecture which may include engines or modules such as a data input engine, data retrieval engine, data transform engine, featurization engine, modeling engine, generative engine, validation engine, feedback engine, and refinement engine. A data input pipeline may obtain structured or unstructured information from various sources, transform the information into model-compatible forms, and store such transformed data in memory or storage accessible to downstream components. A modeling engine may perform tasks such as model training, re-configuration, validation, and testing, executing iterative processes across multiple cycles or passes through training data. A predictive or generative engine may construct outputs based on intermediate representations, learned embeddings, or latent encodings generated by layers such as encoder-decoder structures, attention mechanisms, or multi-layer transformer architectures. Embeddings may represent discrete entities such as words, documents, or images as continuous vectors in high-dimensional spaces, capturing semantic or structural relationships useful for downstream tasks.

Further, the disclosure may provide a distributed or cloud-based operation may include multiple physical or virtual instances of computing devices, distributed across data centers or network boundaries. Functions may be partitioned across machines to achieve parallelism, redundancy, fault tolerance, or improved throughput. Distributed systems may use load balancing mechanisms to maintain stable processing, memory, or bandwidth utilization across clusters and avoid overload conditions. Such deployments may require communication over wired or wireless networks that implement a variety of protocols including HTTP, HTTPS, MQTT, CoAP, or any other suitable communication framework. Communication channels may include local networks, wide-area networks, personal-area networks, or global communication systems, potentially utilizing secure encrypted sessions such as SSL-based channels.

Further, the disclosure may provide an algorithm, process, or flow diagram which may include operations that may occur in sequences, reversed orders, concurrently, or in partially overlapping timelines, depending on the implementation. Blocks representing actions in a flowchart may correspond to program modules, instruction sequences, or hardware logic capable of performing the specified acts. Such operations may manipulate physical quantities such as electrical or magnetic signals stored or transferred among memory units, registers, storage devices, or communication media. Flow diagrams may be realized through software running on general-purpose processors, through dedicated hardware circuits, or through combinations of both.

Further, the disclosure may provide memory, storage, or programmatic constructs which may include program instructions encoded on computer-readable media including electronic, magnetic, optical, electromagnetic, semiconductor, or other tangible media. Examples include RAM, ROM, EEPROM, flash memory, magnetic disks, optical disks, and mechanical encoded structures such as punch cards or raised-pattern media. Such storage media may store instructions that, when executed, configure the memory and therefore configure the computing device itself, causing the device to perform functions described in association with the drawings.

Further, the disclosure may provide a user interface which may include graphical displays, dashboards, selection controls, input fields, monitoring elements, or multimodal interaction surfaces, allowing users to interact with computing systems in speech, touch, gesture, or other modalities. Such interfaces may be presented through client devices, server applications, or remote access platforms and may support visualization of model behavior, systems performance, or configuration parameters.

Further, described features may be combined, rearranged, omitted, or substituted without departing from the principles disclosed. Variations may involve distributing functionality across devices, merging components, implementing features in hardware rather than software, or employing alternative communication protocols. Many such variations and modifications are intended to fall within the scope of the disclosure as understood by persons skilled in the art.

The detailed description of the drawings therefore provides a foundation for describing technical, architectural, and operational aspects of embodiments, while allowing broad flexibility in how such embodiments may be implemented in practice. The scope of such embodiments is governed by the claims rather than the illustrative content of the drawings.

In some embodiments, a system consistent with this disclosure includes one or more client devices, one or more servers, and one or more data stores coupled by one or more networks. The client devices can include, without limitation, mobile phones, tablet computers, laptop or desktop computers, wearable devices, smart displays, vehicles, robots, or other computing platforms equipped with data processing hardware and memory hardware. The servers can include data servers, application servers, web servers, proxy servers, or cloud computing services that provide shared processing, storage, and networking resources. The data stores can include databases, object stores, file systems, or other repositories that persist configuration data, training data, logs, model artifacts, and other information.

The networks can include public and private networks, such as local area networks, wide area networks, and cloud networks, using wired or wireless communication links. The networks can provide routing, addressing, access control, encryption, and related functionality using standard or proprietary protocols.

Each computing device, whether a client device or a server, can include one or more processors, system memory, persistent storage, communication interfaces, and input or output devices. The processors can include general purpose central processing units, graphics processing units, digital signal processors, microcontrollers, application specific integrated circuits, field programmable gate arrays, or other programmable or fixed function processing elements configured to execute instructions or perform logic operations. The memory can include volatile and non-volatile storage, such as random access memory and read only memory. The persistent storage can include solid state drives, magnetic disks, optical media, or other non-transitory computer readable media.

Program code executed by the processors can include operating systems, device drivers, libraries, and application programs, including components that implement portions of the methods described herein. Program code and data can be stored on computer readable media and loaded into memory by standard mechanisms, such as boot loaders, installation programs, or update services.

Input devices can include keyboards, pointing devices, microphones, cameras, touch sensitive surfaces, biometric sensors, and other sensors. Output devices can include displays, speakers, haptic devices, printers, and other actuators. Some devices can support multimodal interaction, allowing combined or sequential input and output through various modalities.

For purposes of this disclosure, artificial intelligence systems may include arrangements of software and hardware that perform tasks such as perception, prediction, planning, or generation based on input data. These systems can employ one or more models, such as statistical models, neural networks, decision trees, or other machine learning models. As used herein, a “model” can refer to a parameterized function, an ensemble of such functions, or a collection of cooperating components that process data and produce outputs.

In some embodiments, the system includes a data input engine that obtains data from one or more sources, such as application logs, sensor streams, structured databases, and unstructured content. The data input engine can retrieve, filter, aggregate, or transform the data into feature representations suitable for model consumption. Data sources can include training data, validation data, and reference data used to evaluate and calibrate model behavior.

A modeling engine can manage one or more training processes for one or more models. The modeling engine can select model architectures, initialize parameters, and apply training algorithms such as supervised learning, semi supervised learning, unsupervised learning, reinforcement learning, or combinations thereof. The modeling engine can also manage hyperparameters, training schedules, and evaluation procedures across epochs or passes through the data.

The system can include a generative response engine or inference engine that receives prompts or other inputs and generates outputs using one or more models. For example, a natural language interface can receive a text prompt, embed or otherwise encode the prompt, process the encoded prompt using a transformer based model or other sequence model, and generate a sequence of tokens that are decoded into an output. The engine can generate multiple candidate outputs and apply validation or ranking logic to select a final result according to quality, safety, or relevance criteria.

A feedback engine can collect explicit or implicit feedback signals, such as user ratings, corrective edits, or outcome metrics derived from downstream tasks. A refinement engine can use such feedback to adjust model parameters, routing logic, or policies, for example by performing additional training steps, updating reward models, or modifying configuration parameters.

In certain embodiments, the disclosed techniques are applied to platforms that include sensors and actuators, such as vehicles, robots, or other machines. The platform can include a processor system that receives signals from cameras, lidar units, radar units, inertial sensors, and other devices, and produces control outputs for steering, propulsion, braking, or other actuators. Sensor data can be captured at various sampling rates and processed by perception models to detect and track objects and infer scene attributes.

Planning and control components can receive outputs from perception models along with route information, traffic rules, and high level goals. These components can generate trajectories or control commands, optionally using reinforcement learned policies, optimization based planners, or hybrid systems. Connections to backend services can permit off board processing, fleet level learning, or remote supervision where appropriate, while on board components can maintain safe operation in the presence of network latency or failures.

The systems described herein can be implemented using centralized, decentralized, or hybrid arrangements. For instance, models may be deployed in cloud environments, on edge devices, or across both, depending on requirements such as latency, privacy, cost, and reliability. Load balancing and resource management components can distribute processing across devices or data centers and can provide elasticity to accommodate changing workloads.

Certain embodiments may expose functionality through application programming interfaces, software development kits, or graphical user interfaces. Client applications can submit requests to backend services, which can apply authentication, authorization, logging, and policy enforcement before invoking models or tools and returning results.

The systems and methods disclosed herein can be implemented in hardware, software, firmware, or any combination thereof. In some embodiments, operations are carried out by one or more processors executing program instructions stored on one or more non-transitory computer readable media. Such media can include, without limitation, semiconductor memory, magnetic storage, optical storage, and combinations thereof. Program instructions, when executed by the processors, cause the processors to perform the operations described herein.

Instructions can be delivered to computing devices in various ways, such as pre installation, physical distribution of media, or transmission over networks. Instructions received over a network can be stored in memory or persistent storage and then executed by one or more processors. Dedicated hardware logic, such as application specific integrated circuits or field programmable gate arrays, can be used alone or in combination with software to implement certain functionality.

Any methods described in connection with embodiments of the present disclosure can be represented as one or more flow diagrams or state diagrams. Blocks in such diagrams can correspond to modules, components, operations, or code segments that implement the associated functionality. Blocks can be reordered, combined, executed concurrently, or omitted according to implementation specific considerations, unless a particular ordering is required by the claims.

Examples and embodiments described herein illustrate, rather than limit, the claimed subject matter. Certain features have been described in connection with particular embodiments for clarity, but other embodiments can include such features in different combinations. Features described in separate embodiments can be combined, and features described in a single embodiment can be separated, unless such combinations or separations are inconsistent with the claims. The scope of the disclosure is defined by the claims and their equivalents.

### Overview:

The present disclosure generally relates to systems and methods for facilitating residential real estate transactions through a network-based platform configured to provide integrated transaction management, property access coordination, listing services, and transaction guidance for buyers and sellers.

In some embodiments, the invention may include a server-based platform configured to enable sellers to list residential properties for sale while maintaining direct control over listing management, showing coordination, and communication with prospective buyers. The platform may operate through one or more computing systems connected through a communication network and may provide user interfaces accessible through client devices such as personal computers, mobile devices, or tablet devices.

In some embodiments, the platform may include functionality for enabling a seller to create a property listing that may be distributed to one or more property search platforms or listing networks. The listing process may include generation of digital listing data that may include property description data, property location data, property media data, and pricing information. The platform may be configured to publish the listing data across multiple online property search systems so that prospective buyers may locate the property through various search interfaces.

In some embodiments, the platform may provide listing preparation services that may include professional property imaging and digital media generation. Property imaging may include capturing photographs or other visual media associated with the property. In some implementations, the imaging process may include generating panoramic image sets, structured image collections, or virtual tour data representing the interior and exterior of the property (e.g. a 360-degree-virtual-tour). These visual assets may be integrated into listing pages that may be dynamically generated by the platform.

In some embodiments, the platform may provide a system set-up process for preparing a property for digital listing and remote viewing. The system set-up process may include installation or configuration of monitoring devices such as security cameras positioned within the property. The monitoring devices may enable observation of property access events during property showings. In some embodiments, the monitoring devices may transmit monitoring data to the platform through a communication network so that access events may be recorded or reviewed by the seller.

In some embodiments, the platform may enable sellers to manage property showings through a remote scheduling mechanism. The scheduling functionality may allow sellers to define availability windows during which prospective buyers may request property showings. The platform may generate showing schedule data that may be stored within a server-side database and may be accessible to authorized users through the platform interface. The scheduling process may support automated coordination of showing requests and may permit sellers to approve or reject proposed showing sessions.

In some embodiments, the platform may perform buyer verification procedures before granting access to a property for viewing. The buyer verification procedures may include processing identity information, background screening information, or proof-of-funds documentation provided by prospective buyers. Verification processing may generate verification status data that may be used to determine whether a prospective buyer may be permitted to participate in a property showing. In some embodiments, only buyers that satisfy predefined verification criteria may be authorized to access the property.

In some embodiments, the platform may support unattended property showings in which verified buyers may tour the property without requiring the presence of an agent or homeowner. In such implementations, access to the property may be controlled through remotely operated locking mechanisms or other entry control systems. Access authorization data may be generated by the platform to permit entry during approved showing sessions while maintaining monitoring of the property through installed camera devices.

In some embodiments, the platform may enable direct communication between buyers and sellers through integrated messaging or consultation features. Communication interfaces may allow sellers to receive feedback following property showings and may also allow buyers to submit inquiries regarding the property. This communication capability may support transparency in the transaction process by allowing both parties to exchange relevant information directly through the platform.

In some embodiments, the platform may provide guidance services to assist sellers in evaluating purchase offers submitted by prospective buyers. When an offer is received, the platform may present information associated with the offer, including proposed purchase price, financing conditions, or contingency conditions. The platform may further generate transaction parameter data that may be used to assist sellers in forming or reviewing contractual agreements associated with the sale of the property.

In some embodiments, once an offer has been conditionally accepted, the platform may facilitate subsequent transaction stages associated with property inspection, appraisal, and closing procedures. For example, the platform may coordinate scheduling of a property inspection in which a qualified inspector evaluates the property condition. Inspection data generated during this process may be provided to the seller and buyer to assist in determining whether additional negotiations or repairs may be required before closing.

In some embodiments, the platform may also support coordination of property appraisal activities. During the appraisal process, a lender or financial institution may determine an estimated market value of the property. The appraisal data may be analyzed to verify whether the agreed purchase price corresponds with market valuation. The platform may provide analytical tools enabling sellers to compare listing price information with appraisal results to identify potential discrepancies that may affect financing approval.

In some embodiments, the platform may facilitate documentation and signing procedures associated with escrow and closing operations. Escrow documentation may include transaction agreements, title transfer documentation, and other legally required documents necessary to complete the sale of the property. The platform may integrate electronic document processing functionality that enables parties to review and execute transaction documents through digital signature technologies.

In some embodiments, the platform may also provide tools that assist buyers in evaluating financing options associated with the property purchase. These tools may include mortgage estimation capabilities that calculate potential payment projections or estimated closing costs based on financing parameters such as loan amount, interest rate, and repayment period. Such tools may assist buyers in determining affordability and may support informed decision-making during the transaction process.

In some embodiments, the platform may provide additional property data to buyers to assist in evaluating potential purchases. For example, property listing pages may include location-specific information such as crime statistics, school ratings, and proximity to amenities. These additional data sources may enable buyers to perform more comprehensive evaluation of a property prior to submitting an offer.

In some embodiments, the platform may provide educational resources to assist both buyers and sellers in navigating the real estate transaction process. Educational resources may include instructional content explaining transaction steps, documentation requirements, and procedural considerations associated with listing or purchasing a property. The educational resources may be delivered through multimedia formats such as instructional videos or interactive tutorials.

In some embodiments, the platform may provide a transaction workflow that includes multiple stages corresponding to different phases of the property sale process. For example, the workflow may include listing preparation, property marketing, buyer verification, showing management, offer evaluation, inspection, appraisal, escrow processing, and transaction closing. Each stage may be associated with specific system functions that facilitate progression of the transaction from initial listing to final sale completion.

In some embodiments, the platform may be configured to provide a complete seller-managed transaction experience that reduces reliance on traditional brokerage representation. By enabling sellers to manage listings, coordinate showings, communicate with buyers, and process transaction documentation through a unified digital platform, the system may reduce transaction costs and increase transparency throughout the sale process.

In some embodiments, the platform may generate analytics or reporting information that allows sellers to track listing activity, buyer engagement, showing frequency, and transaction progression. Such analytics may enable sellers to make informed decisions regarding pricing strategies, showing availability, and negotiation approaches.

In some embodiments, the architecture of the platform may include server-side computing infrastructure that performs data processing operations associated with listing management, user authentication, verification analysis, and transaction coordination. Data associated with property listings, user profiles, verification records, showing schedules, and transaction documentation may be stored within databases accessible to the platform servers.

In some embodiments, the platform may operate as a software-as-a-service environment in which users access the functionality through web-based interfaces or application software executing on client devices. Communication between client devices and server systems may occur through standard network protocols over the Internet or other communication networks.

### Example Comparison Between the Resibuy Platform and a Conventional Real Estate Transaction Model:

In some embodiments, the platform may provide a transaction model that differs from a conventional real estate sales model with respect to cost structure, participant interaction, and transaction management. The comparison may illustrate the operational and economic differences between a seller-managed digital transaction platform and a traditional agent-mediated sales process.

In a conventional residential real estate transaction, a property sale may typically involve listing and selling agents who charge a combined commission that may range from approximately 5% to 6% of the sale price of the property. For example, if a property has a sale price of $750,000, a commission rate of approximately 5.5% may result in a commission payment of approximately $41,250 payable to real estate agents. In such a transaction structure, the commission amount may be deducted from the proceeds of the sale received by the seller.

In contrast, in some embodiments of the disclosed platform, the transaction may be facilitated through a seller-controlled listing environment in which the seller may directly manage listing, showing coordination, and communication with prospective buyers. The platform may provide services such as listing creation, property imaging, showing management, buyer verification, and transaction coordination without requiring traditional agent representation. In such implementations, the platform may charge a substantially reduced fee that may correspond to approximately 30% of the typical traditional commission amount.

Using the same example property sale price of $750,000, a fee structure corresponding to approximately 30% of the traditional commission level may result in a cost of approximately $12,375 to the seller. This reduced fee structure may allow sellers to retain a significantly larger portion of the proceeds from the sale when compared with a traditional commission-based transaction model.

In some embodiments, the reduction in transaction costs may benefit both sellers and buyers. Sellers may retain a larger portion of the property sale proceeds because agent commissions may be significantly reduced or eliminated. Buyers may also benefit because the reduced transaction cost environment may allow properties to be offered at lower effective purchase prices while maintaining favorable financial outcomes for sellers.

In addition to cost differences, the operational structure of the transaction may also differ between the two models. In a conventional model, buyers and sellers may communicate primarily through agents, and showings may typically require the presence or coordination of licensed agents. In some embodiments of the disclosed platform, buyers and sellers may communicate directly through the platform interface, and sellers may maintain direct control over scheduling and managing property showings.

In some embodiments, the platform may also provide integrated transaction tools such as educational resources, listing services, showing scheduling mechanisms, and buyer verification capabilities that may streamline the transaction workflow. These features may allow a seller to independently manage a property listing and sale process without relying on traditional brokerage services.

Accordingly, the comparison illustrates how the disclosed platform may provide a cost-efficient and technology-enabled alternative to a conventional commission-based real estate sales model while supporting secure transaction coordination and improved transparency between buyers and sellers.

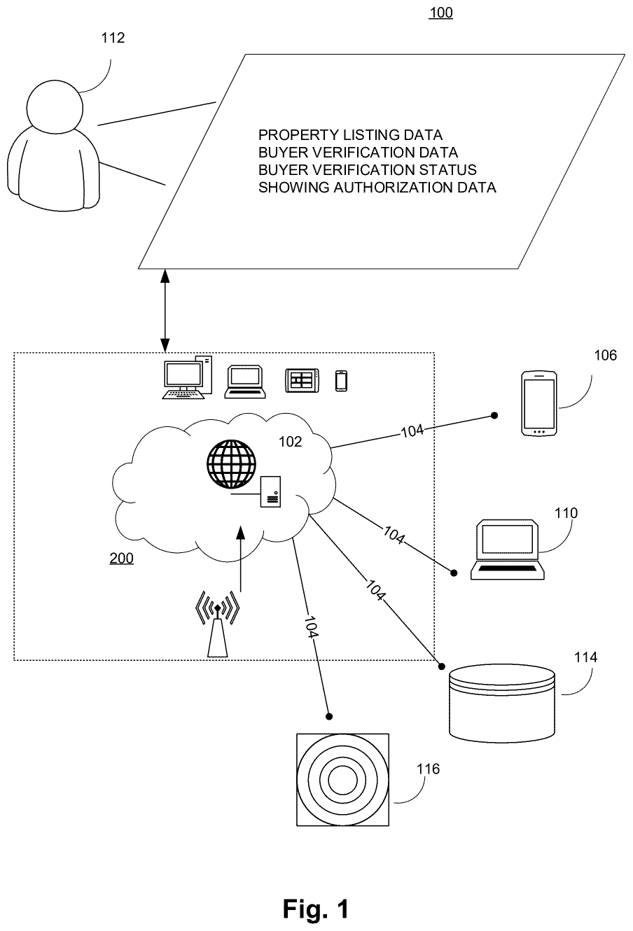

FIG. 1 is an illustration of an online platform 100 consistent with various embodiments of the present disclosure. By way of non-limiting example, the online platform 100 may be hosted on a centralized server 102, such as, for example, a cloud computing service. The centralized server 102 may communicate with other network entities, such as, for example, a mobile device 106 (such as a smartphone, a laptop, a tablet computer etc.), other electronic devices 110 (such as desktop computers, server computers etc.), databases 114, and sensors 116 over a communication network 104, such as, but not limited to, the Internet. Further, users of the online platform 100 may include relevant parties such as, but not limited to, end-users, administrators, service providers, service consumers and so on. Accordingly, in some instances, electronic devices operated by the one or more relevant parties may be in communication with the platform.

A user 112, such as the one or more relevant parties, may access online platform 100 through a web based software application or browser. The web based software application may be embodied as, for example, but not be limited to, a website, a web application, a desktop application, and a mobile application compatible with a computing device 200.

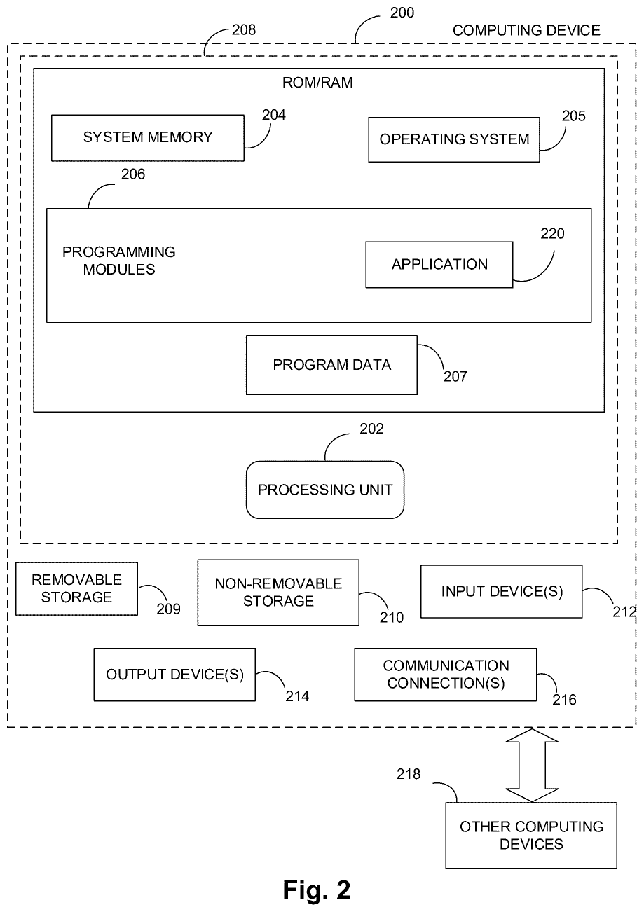

With reference to FIG. 2, a system consistent with an embodiment of the disclosure may include a computing device or cloud service, such as computing device 200. In a basic configuration, computing device 200 may include at least one processing unit 202 and a system memory 204. Depending on the configuration and type of computing device, system memory 204 may comprise, but is not limited to, volatile (e.g. random-access memory (RAM)), non-volatile (e.g. read-only memory (ROM)), flash memory, or any combination. System memory 204 may include operating system 205, one or more programming modules 206, and may include a program data 207. Operating system 205, for example, may be suitable for controlling computing device 200's operation. In one embodiment, programming modules 206 may include image-processing module, machine learning module. Furthermore, embodiments of the disclosure may be practiced in conjunction with a graphics library, other operating systems, or any other application program and is not limited to any particular application or system. This basic configuration is illustrated in FIG. 2 by those components within a dashed line 208.

Computing device 200 may have additional features or functionality. For example, computing device 200 may also include additional data storage devices (removable and/or non-removable) such as, for example, magnetic disks, optical disks, or tape. Such additional storage is illustrated in FIG. 2 by a removable storage 209 and a non-removable storage 210. Computer storage media may include volatile and non-volatile, removable and non-removable media implemented in any method or technology for storage of information, such as computer-readable instructions, data structures, program modules, or other data. System memory 204, removable storage 209, and non-removable storage 210 are all computer storage media examples (i.e., memory storage.) Computer storage media may include, but is not limited to, RAM, ROM, electrically erasable read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store information and which can be accessed by computing device 200. Any such computer storage media may be part of device 200. Computing device 200 may also have input device(s) 212 such as a keyboard, a mouse, a pen, a sound input device, a touch input device, a location sensor, a camera, a biometric sensor, etc. Output device(s) 214 such as a display, speakers, a printer, etc. may also be included. The aforementioned devices are examples and others may be used.

Computing device 200 may also contain a communication connection 216 that may allow device 200 to communicate with other computing devices 218, such as over a network in a distributed computing environment, for example, an intranet or the Internet. Communication connection 216 is one example of communication media. Communication media may typically be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, radio frequency (RF), infrared, and other wireless media. The term computer readable media as used herein may include both storage media and communication media.

As stated above, a number of program modules and data files may be stored in system memory 204, including operating system 205. While executing on processing unit 202, programming modules 206 (e.g., application 220 such as a media player) may perform processes including, for example, one or more stages of methods, algorithms, systems, applications, servers, databases as described above. The aforementioned process is an example, and processing unit 202 may perform other processes. Other programming modules that may be used in accordance with embodiments of the present disclosure may include machine learning applications.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general purpose graphics processor-based systems, multiprocessor systems, microprocessor-based or programmable consumer electronics, application specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

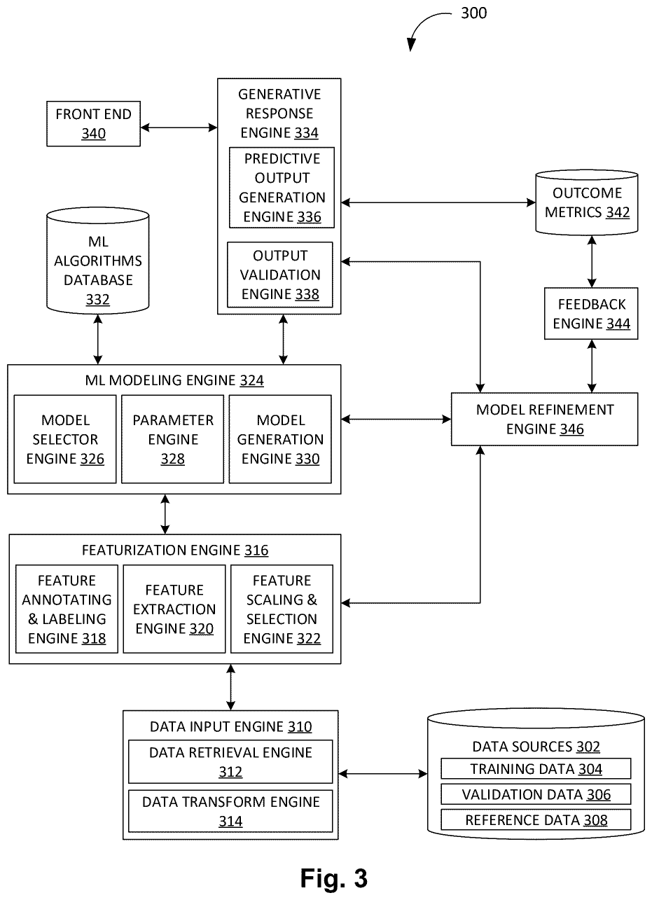

FIG. 3 is a block diagram illustrating a machine-learning system 300 for implementing various embodiments of this disclosure, in accordance with some embodiments. Although the disclosed machine-learning system 300 depicts particular system components and an arrangement of such components, the given depiction is to facilitate a discussion of the present technology and should not be considered limiting unless specified in the appended claims. For, example some components that are illustrated as separate, may be combined with other components and some components may be divided into separate components.

Accordingly, the machine-learning system 300 may include a plurality of interrelated modules and engines configured to implement a machine-learning pipeline. Further, the machine-learning system 300 may include a data sources module 302 that is made up of a training data repository 304, a validation data repository 306, and a reference data repository 308, each repository being configured to store respective classes of input records and reference information. Further, the machine-learning system 300 may include a data input engine 310 configured to receive data from the data sources module 302. Further, the data input engine 310 may include a data retrieval engine 312 configured to access and ingest data from the repositories (304, 306, 308), and a data transform engine 314 configured to perform initial normalization, parsing and format conversion on the ingested data. Further, the data input engine 310 may be implemented on a computing device.

Further, the machine-learning system 300 may include a featurization engine 316 configured to prepare temporal and predictive representations of transformed data. Further, the featurization engine 316 may include a feature annotating & labeling engine 318 for applying labels and annotations to data instances, a feature extraction engine 320 for deriving feature vectors and candidate predictors, and a feature scaling & selection engine 322 for performing numerical scaling, dimensionality reduction and selection of salient features. Further, the featurization engine 316 may be implemented on the computing device.

Further, the machine-learning system 300 may include a machine learning (ML) modeling engine 324 configured to construct predictive models from selected features. Further, the ML modeling engine 324 may include a model selector engine 326 for selecting among candidate model classes, a parameter engine 328 for determining and tuning hyper parameters, and a model generation engine 330 for instantiating and training model artifacts according to selected architectures and parameters. Further, the machine-learning system 300 may include an ML algorithms database 332 configured to store algorithmic implementations, model templates and associated metadata and to be accessible by components of the ML modeling engine 324. Further, the ML modeling engine 324 may be implemented on the computing device.

Further, the machine-learning system 300 may include a generative response engine 334 configured to produce user-facing outputs based on the trained models. Further, the generative response engine 334 may include a predictive output generation engine 336 for generating predictions or synthesized responses and an output validation engine 338 for verifying, filtering and validating generated outputs against predefined criteria and reference data. Further, the machine-learning system 300 may include a front end 340 configured to present validated outputs to end users and to collect interaction signals. Further, the machine-learning system 300 may include an outcome metrics module 342 configured to compute performance measures, accuracy statistics and other evaluation metrics derived from model outputs and user interactions. Further, the generative response engine 334 may be implemented on the computing device.

Further, the machine-learning system 300 may include a feedback engine 344 configured to aggregate outcome metrics and user feedback and to format such information for reuse. Further, the machine-learning system 300 may include a model refinement engine 346 configured to receive feedback from the feedback engine 344 and the outcome metrics module 342, and to effect iterative updates to the ML modeling engine 324 and to the ML algorithms database 332. Further, the components are communicatively coupled so that data and control signals are exchanged among the repositories (304, 306, 308), the data input engine 310, the featurization engine 316, the ML modeling engine 324 (with algorithmic support from the ML algorithms database 332), the generative response engine 334 and the front end 340 for output generation. Further, the outcome metrics 342 and the feedback engine 344 provide closed-loop signals to the model refinement engine 346 to enable retraining, parameter adjustment and algorithm selection, thereby enabling cooperative execution of data acquisition, feature engineering, model construction, output generation, validation, evaluation and iterative refinement within the disclosed machine-learning system 300. Further, the feedback engine 344 may be implemented on the computing device.

Any or each engine of the machine-learning system 300 may be and/or may include a module (e.g., a program module), which may be a hardware unit configured to be used with other components or a part of a program that performs a particular function. Further, any or each engine of the machine-learning system 300 may be implemented using a computing device.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid state storage (e.g., USB drive), or a CD-ROM, a carrier wave from the Internet, or other forms of RAM or ROM. Further, the disclosed methods'stages may be modified in any manner, including by reordering stages and/or inserting or deleting stages, without departing from the disclosure.

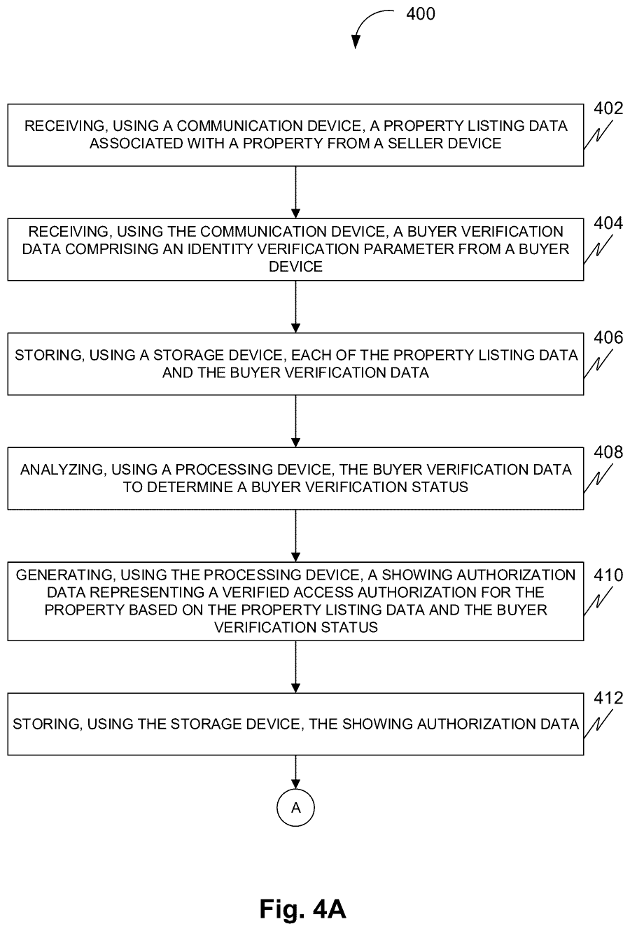

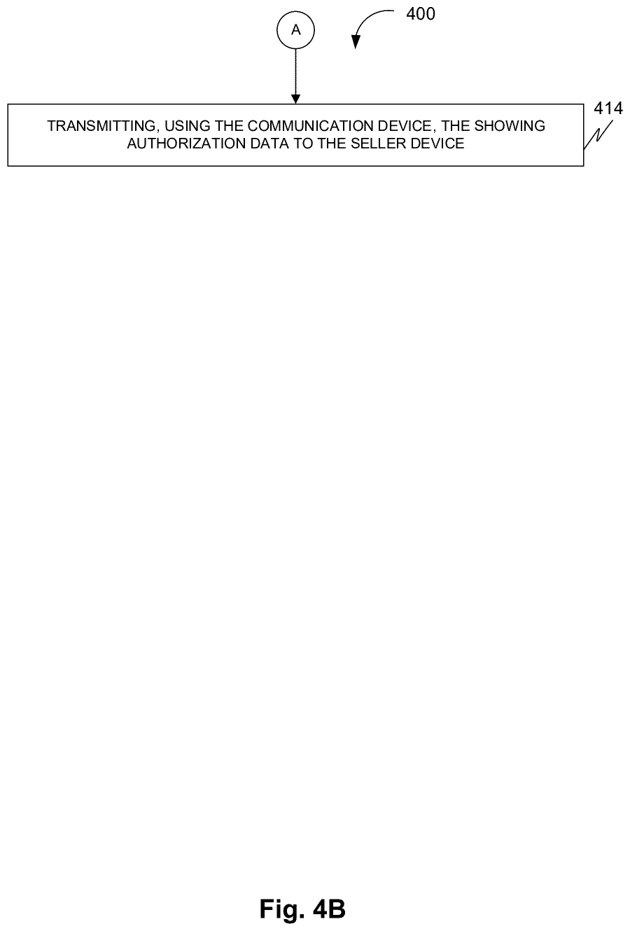

FIG. 4A and FIG. 4B illustrate a flowchart of a method 400 of facilitating controlled remote property access authorization through a software-as-a-service real estate transaction platform, in accordance with some embodiments.

Accordingly, the method 400 may include a step 402 of receiving, using a communication device 1402, a property listing data associated with a property from a seller device. Further, the method 400 may include a step 404 of receiving, using the communication device 1402, a buyer verification data comprising an identity verification parameter from a buyer device. Further, the method 400 may include a step 406 of storing, using a storage device 1406, each of the property listing data and the buyer verification data. Further, the method 400 may include a step 408 of analyzing, using a processing device 1404, the buyer verification data to determine a buyer verification status. Further, the method 400 may include a step 410 of generating, using the processing device 1404, a showing authorization data representing a verified access authorization for the property based on the property listing data and the buyer verification status. Further, the method 400 may include a step 412 of storing, using the storage device 1406, the showing authorization data. Further, the method 400 may include a step 414 of transmitting, using the communication device 1402, the showing authorization data to the seller device.

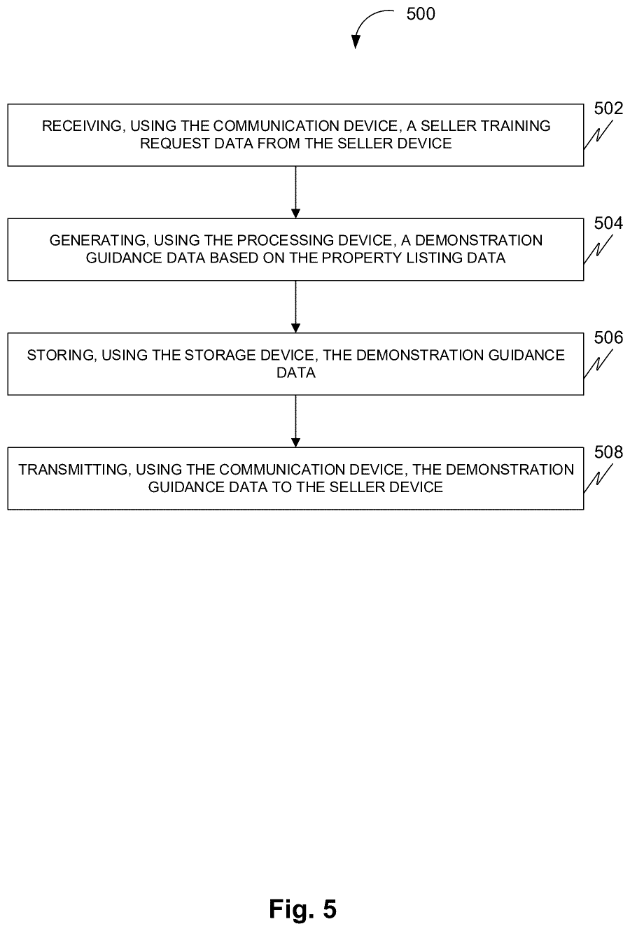

FIG. 5 illustrates a flowchart of a method 500 of facilitating controlled remote property access authorization through a software-as-a-service real estate transaction platform including generating, using the processing device 1404, a demonstration guidance data, in accordance with some embodiments.

Further, in some embodiments, the method 500, further may include a step 502 of receiving, using the communication device 1402, a seller training request data from the seller device. Further, in some embodiments, the method 500, further may include a step 504 of generating, using the processing device 1404, a demonstration guidance data based on the property listing data. Further, in some embodiments, the method 500, further may include a step 506 of storing, using the storage device 1406, the demonstration guidance data. Further, in some embodiments, the method 500, further may include a step 508 of transmitting, using the communication device 1402, the demonstration guidance data to the seller device.

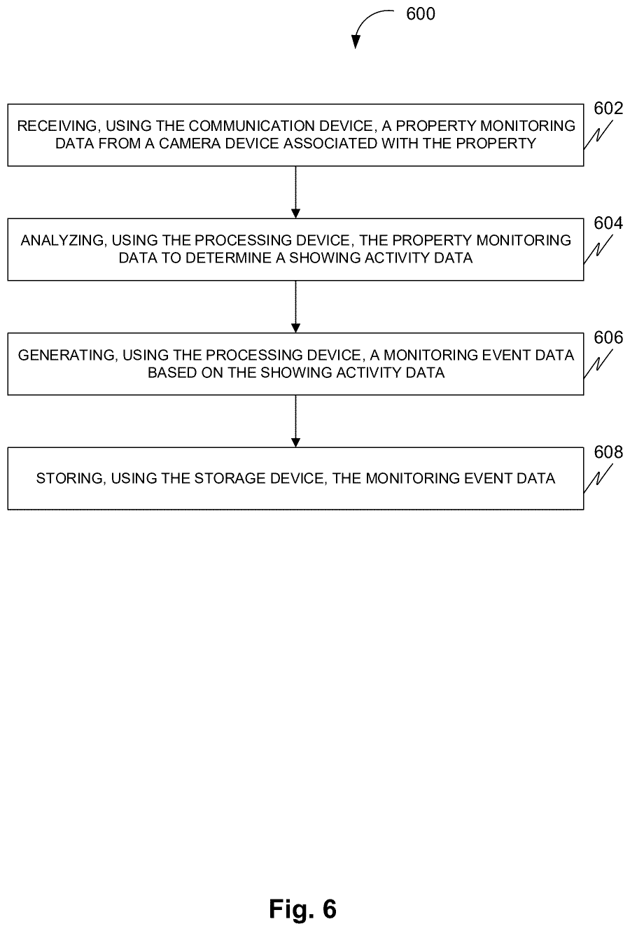

FIG. 6 illustrates a flowchart of a method 600 of facilitating controlled remote property access authorization through a software-as-a-service real estate transaction platform including generating, using the processing device 1404, a monitoring event data, in accordance with some embodiments.

Further, in some embodiments, the method 600, further may include a step 602 of receiving, using the communication device 1402, a property monitoring data from a camera device associated with the property. Further, in some embodiments, the method 600, further may include a step 604 of analyzing, using the processing device 1404, the property monitoring data to determine a showing activity data. Further, in some embodiments, the method 600, further may include a step 606 of generating, using the processing device 1404, a monitoring event data based on the showing activity data. Further, in some embodiments, the method 600, further may include a step 608 of storing, using the storage device 1406, the monitoring event data.

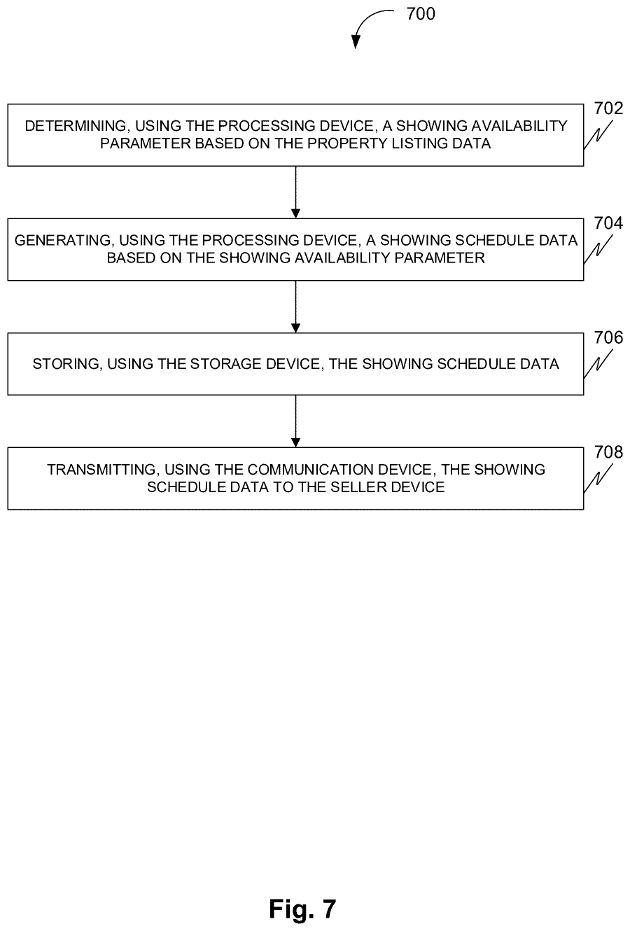

FIG. 7 illustrates a flowchart of a method 700 of facilitating controlled remote property access authorization through a software-as-a-service real estate transaction platform including generating, using the processing device 1404, a showing schedule data, in accordance with some embodiments.

Further, in some embodiments, the method 700, further may include a step 702 of determining, using the processing device 1404, a showing availability parameter based on the property listing data. Further, in some embodiments, the method 700, further may include a step 704 of generating, using the processing device 1404, a showing schedule data based on the showing availability parameter. Further, in some embodiments, the method 700, further may include a step 706 of storing, using the storage device 1406, the showing schedule data. Further, in some embodiments, the method 700, further may include a step 708 of transmitting, using the communication device 1402, the showing schedule data to the seller device.

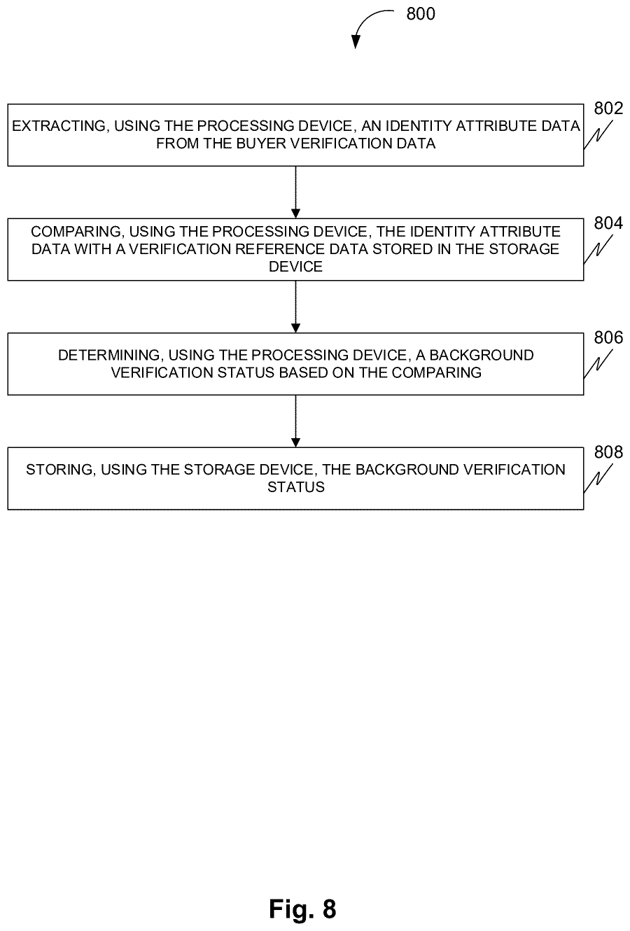

FIG. 8 illustrates a flowchart of a method 800 of facilitating controlled remote property access authorization through a software-as-a-service real estate transaction platform including determining, using the processing device 1404, a background verification status, in accordance with some embodiments.

Further, in some embodiments, the analyzing the buyer verification data may include a step 802 of extracting, using the processing device 1404, an identity attribute data from the buyer verification data. Further, the analyzing the buyer verification data may include a step 804 of comparing, using the processing device 1404, the identity attribute data with a verification reference data stored in the storage device 1406. Further, the analyzing the buyer verification data may include a step 806 of determining, using the processing device 1404, a background verification status based on the comparing. Further, the analyzing the buyer verification data may include a step 808 of storing, using the storage device 1406, the background verification status.

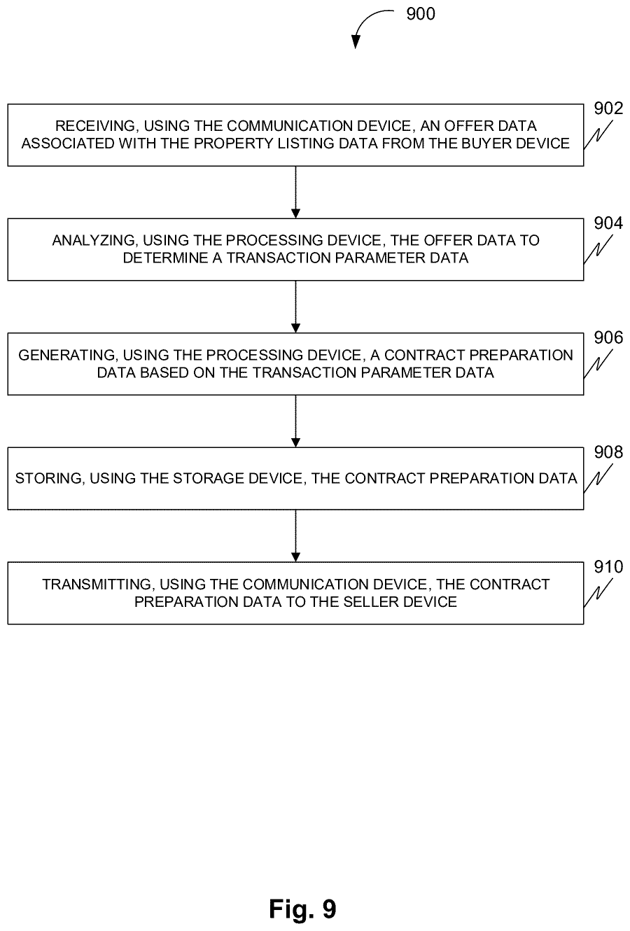

FIG. 9 illustrates a flowchart of a method 900 of facilitating controlled remote property access authorization through a software-as-a-service real estate transaction platform including generating, using the processing device 1404, a contract preparation data, in accordance with some embodiments.

Further, in some embodiments, the method 900, further may include a step 902 of receiving, using the communication device 1402, an offer data associated with the property listing data from the buyer device. Further, in some embodiments, the method 900, further may include a step 904 of analyzing, using the processing device 1404, the offer data to determine a transaction parameter data. Further, in some embodiments, the method 900, further may include a step 906 of generating, using the processing device 1404, a contract preparation data based on the transaction parameter data. Further, in some embodiments, the method 900, further may include a step 908 of storing, using the storage device 1406, the contract preparation data. Further, in some embodiments, the method 900, further may include a step 910 of transmitting, using the communication device 1402, the contract preparation data to the seller device.

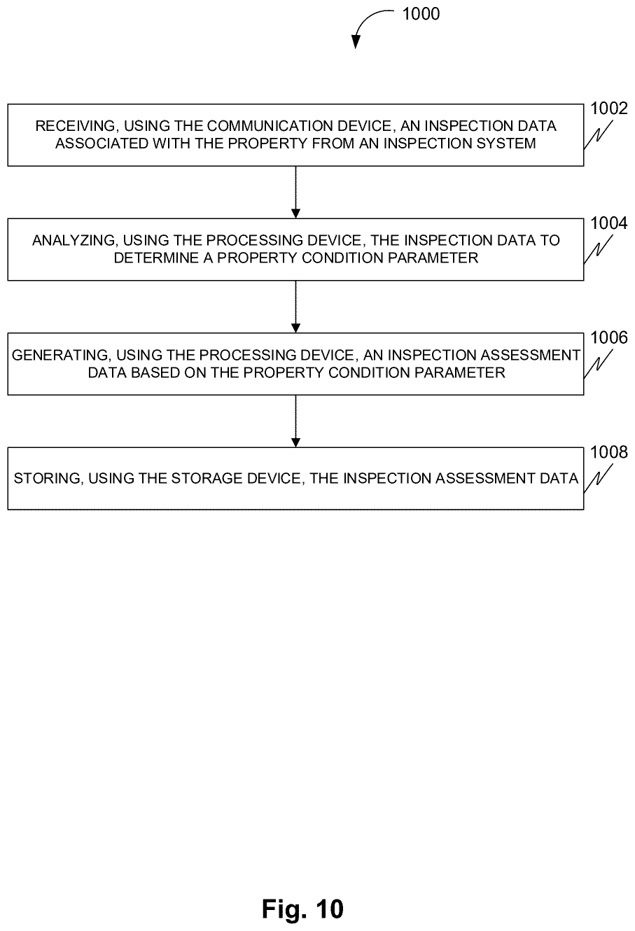

FIG. 10 illustrates a flowchart of a method 1000 of facilitating controlled remote property access authorization through a software-as-a-service real estate transaction platform including generating, using the processing device 1404, an inspection assessment data, in accordance with some embodiments.

Further, in some embodiments, the method 1000, further may include a step 1002 of receiving, using the communication device 1402, an inspection data associated with the property from an inspection system. Further, in some embodiments, the method 1000, further may include a step 1004 of analyzing, using the processing device 1404, the inspection data to determine a property condition parameter. Further, in some embodiments, the method 1000, further may include a step 1006 of generating, using the processing device 1404, an inspection assessment data based on the property condition parameter. Further, in some embodiments, the method 1000, further may include a step 1008 of storing, using the storage device 1406, the inspection assessment data.

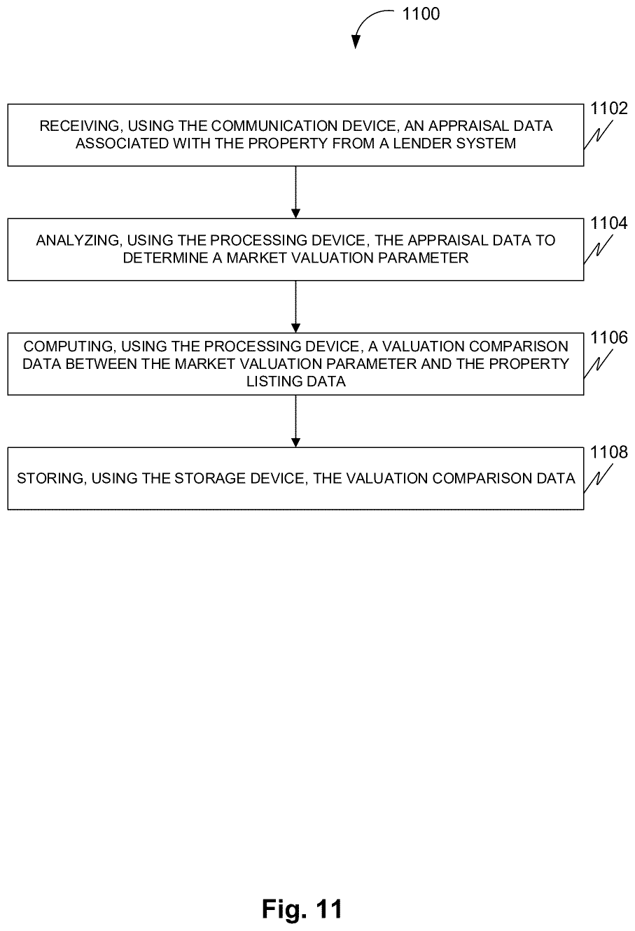

FIG. 11 illustrates a flowchart of a method 1100 of facilitating controlled remote property access authorization through a software-as-a-service real estate transaction platform including computing, using the processing device 1404, a valuation comparison data between the market valuation parameter and the property listing data, in accordance with some embodiments.

Further, in some embodiments, the method 1100, further may include a step 1102 of receiving, using the communication device 1402, an appraisal data associated with the property from a lender system. Further, in some embodiments, the method 1100, further may include a step 1104 of analyzing, using the processing device 1404, the appraisal data to determine a market valuation parameter. Further, in some embodiments, the method 1100, further may include a step 1106 of computing, using the processing device 1404, a valuation comparison data between the market valuation parameter and the property listing data. Further, in some embodiments, the method 1100, further may include a step 1108 of storing, using the storage device 1406, the valuation comparison data.

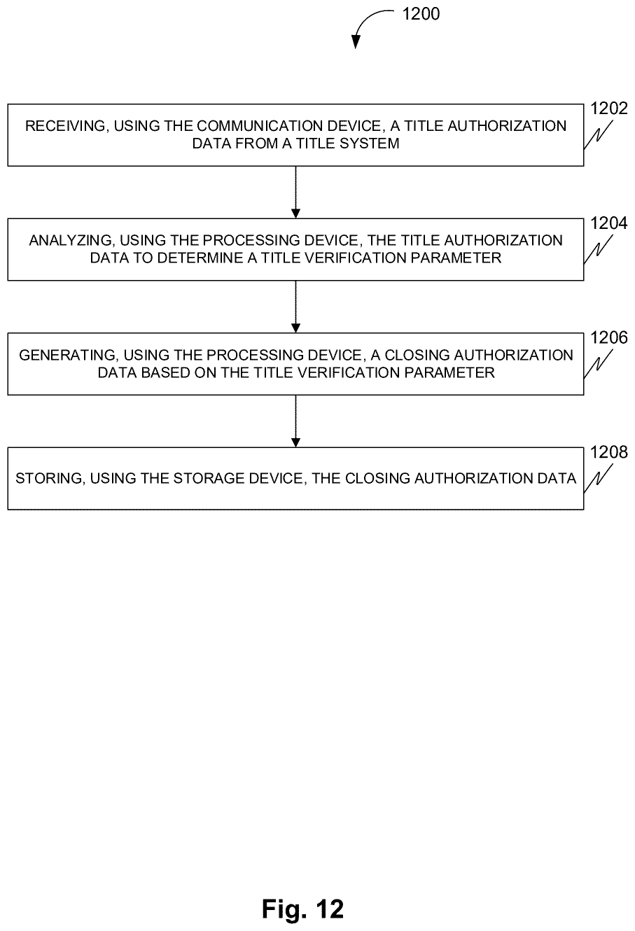

FIG. 12 illustrates a flowchart of a method 1200 of facilitating controlled remote property access authorization through a software-as-a-service real estate transaction platform including generating, using the processing device 1404, a closing authorization data, in accordance with some embodiments.

Further, in some embodiments, the method 1200, further may include a step 1202 of receiving, using the communication device 1402, a title authorization data from a title system. Further, in some embodiments, the method 1200, further may include a step 1204 of analyzing, using the processing device 1404, the title authorization data to determine a title verification parameter. Further, in some embodiments, the method 1200, further may include a step 1206 of generating, using the processing device 1404, a closing authorization data based on the title verification parameter. Further, in some embodiments, the method 1200, further may include a step 1208 of storing, using the storage device 1406, the closing authorization data.

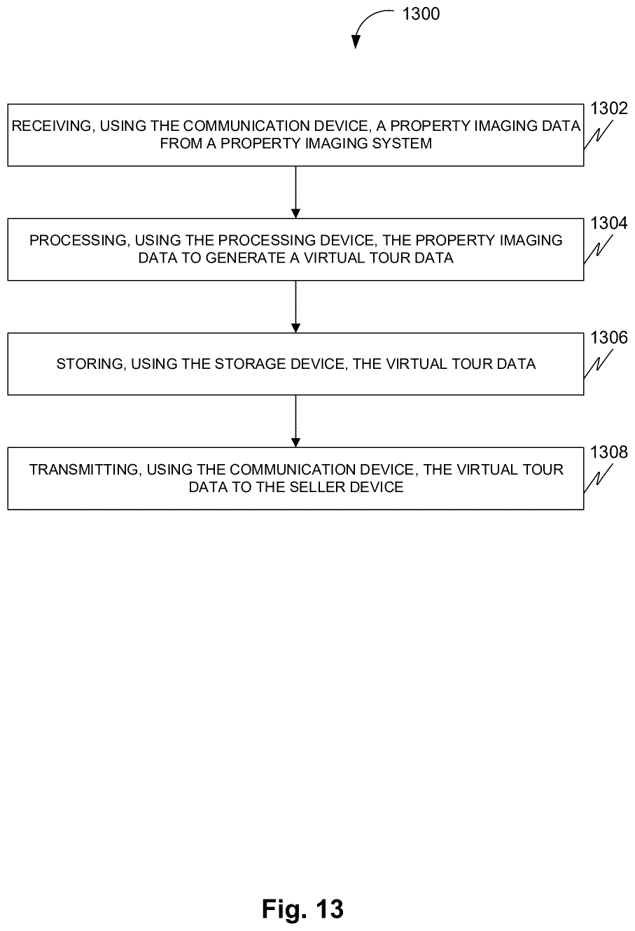

FIG. 13 illustrates a flowchart of a method 1300 of facilitating controlled remote property access authorization through a software-as-a-service real estate transaction platform including processing, using the processing device 1404, the property imaging data to generate a virtual tour data, in accordance with some embodiments.

Further, in some embodiments, the method 1300, further may include a step 1302 of receiving, using the communication device 1402, a property imaging data from a property imaging system. Further, in some embodiments, the method 1300, further may include a step 1304 of processing, using the processing device 1404, the property imaging data to generate a virtual tour data. Further, in some embodiments, the method 1300, further may include a step 1306 of storing, using the storage device 1406, the virtual tour data. Further, in some embodiments, the method 1300, further may include a step 1308 of transmitting, using the communication device 1402, the virtual tour data to the seller device.

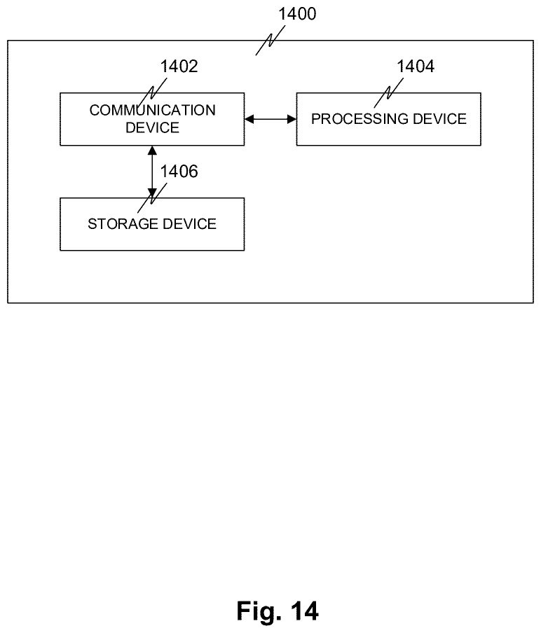

FIG. 14 illustrates a block diagram of a system 1400 of facilitating controlled remote property access authorization through a software-as-a-service real estate transaction platform, in accordance with some embodiments.

Accordingly, the system 1400 may include a communication device 1402. Further, the communication device 1402 may be configured for receiving a property listing data associated with a property from a seller device. Further, the communication device 1402 may be configured for receiving a buyer verification data comprising an identity verification parameter from a buyer device. Further, the communication device 1402 may be configured for transmitting a showing authorization data to the seller device. Further, the system 1400 may include a processing device 1404. Further, the processing device 1404 may be configured for analyzing the buyer verification data to determine a buyer verification status. Further, the processing device 1404 may be configured for generating the showing authorization data representing a verified access authorization for the property based on the property listing data and the buyer verification status. Further, the system 1400 may include a storage device 1406 which may be configured for storing each of the property listing data, the buyer verification data and the showing authorization data.

Further, in some embodiments, the communication device 1402 may be further configured for receiving a seller training request data from the seller device. Further, the communication device 1402 may be further configured for transmitting a demonstration guidance data to the seller device. Further, the processing device 1404 may be further configured for generating the demonstration guidance data based on the property listing data. Further, the storage device 1406 may be further configured for storing the demonstration guidance data.

Further, in some embodiments, the communication device 1402 may be further configured for receiving a property monitoring data from a camera device associated with the property. Further, the processing device 1404 may be further configured for analyzing the property monitoring data to determine a showing activity data. Further, the processing device 1404 may be further configured for generating a monitoring event data based on the showing activity data. Further, the storage device 1406 may be further configured for storing the monitoring event data.

Further, in some embodiments, the processing device 1404 may be further configured for determining a showing availability parameter based on the property listing data. Further, the processing device 1404 may be further configured for generating a showing schedule data based on the showing availability parameter. Further, the storage device 1406 may be further configured for storing the showing schedule data. Further, the communication device 1402 may be further configured for transmitting the showing schedule data to the seller device.

Further, in some embodiments, the processing device 1404 may be further configured for extracting an identity attribute data from the buyer verification data. Further, the processing device 1404 may be further configured for comparing the identity attribute data with a verification reference data stored in the storage device 1406. Further, the processing device 1404 may be further configured for determining a background verification status based on the comparing. Further, the storage device 1406 may be further configured for storing the background verification status.

Further, in some embodiments, the communication device 1402 may be further configured for receiving an offer data associated with the property listing data from the buyer device. Further, the processing device 1404 may be further configured for analyzing the offer data to determine a transaction parameter data. Further, the processing device 1404 may be further configured for generating a contract preparation data based on the transaction parameter data. Further, the storage device 1406 which may be configured for storing the contract preparation data. Further, the communication device 1402 may be further configured for transmitting the contract preparation data to the seller device.

Further, in some embodiments, the communication device 1402 may be further configured for receiving an inspection data associated with the property from an inspection system, may. Further, the processing device 1404 may be further configured for analyzing the inspection data to determine a property condition parameter. Further, the processing device 1404 may be further configured for generating an inspection assessment data based on the property condition parameter. Further, the storage device 1406 further which may be configured for storing the inspection assessment data.

Further, in some embodiments, the communication device 1402 may be further configured for receiving an appraisal data associated with the property from a lender system, may. Further, the processing device 1404 may be further configured for analyzing the appraisal data to determine a market valuation parameter. Further, the processing device 1404 may be further configured for computing a valuation comparison data between the market valuation parameter and the property listing data. Further, the storage device 1406 may be further configured for storing the valuation comparison data.

Further, in some embodiments, the communication device 1402 may be further configured for receiving a title authorization data from a title system, may. Further, the processing device 1404 may be further configured for analyzing the title authorization data to determine a title verification parameter. Further, the processing device 1404 may be further configured for generating a closing authorization data based on the title verification parameter. Further, the storage device 1406 which may be configured for storing the closing authorization data.

In some embodiments, the communication device 1402 may be further configured for receiving a property imaging data from a property imaging system, may. Further, the processing device 1404 may be further configured for processing the property imaging data to generate a virtual tour data. Further, the storage device 1406 may be further configured for storing the virtual tour data. Further, the communication device 1402 may be further configured for transmitting the virtual tour data to the seller device.

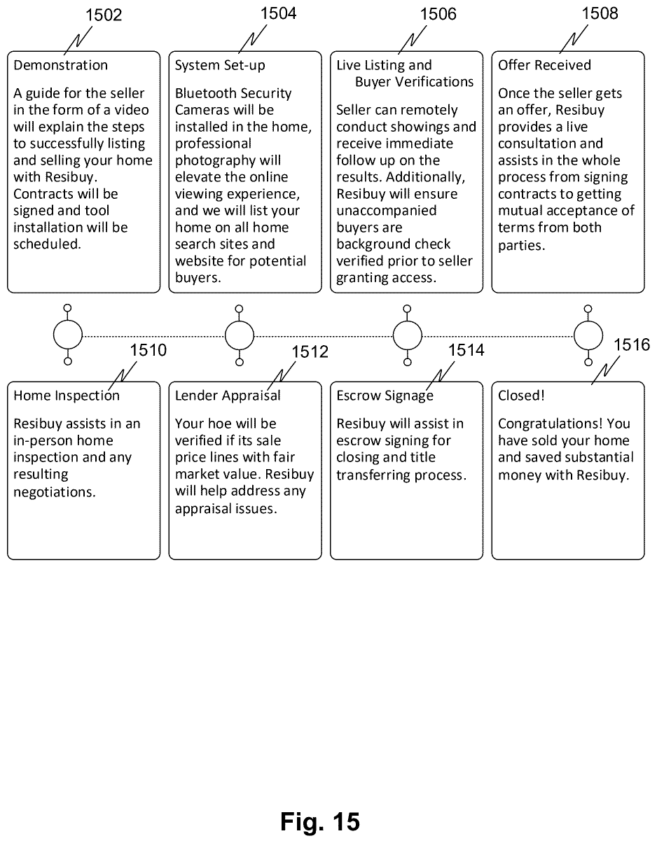

FIG. 15 illustrates an exemplary workflow diagram representing a transaction process implemented by a real estate transaction platform, according to some embodiments.

In some embodiments, the process may begin with step 1502, which may correspond to a demonstration guidance stage. In some embodiments, a demonstration video may be provided to a seller to explain steps involved in listing and selling a property using the platform. The demonstration guidance may provide instructions associated with preparing a property listing, initiating a transaction workflow, and understanding operational procedures associated with the platform. In some embodiments, the demonstration guidance may also initiate scheduling of installation services and configuration activities associated with property listing preparation.

In some embodiments, the process may proceed to step 1504, which may correspond to a system set-up stage. In some embodiments, this stage may include preparation of the property for digital listing and showing management. For example, one or more monitoring devices, such as security cameras, may be installed in the property. In some embodiments, professional imaging of the property may also be performed to generate listing media that may be used to create an online listing. In some embodiments, listing data associated with the property may be distributed to multiple property search platforms or listing networks to increase visibility to potential buyers.

In some embodiments, the process may proceed to step 1506, which may correspond to a listing activation and buyer verification stage. In some embodiments, the property listing may become active and accessible through the platform, allowing prospective buyers to request showings. In some embodiments, the platform may perform buyer verification prior to granting property access. The verification may include processing identity-related information or performing background screening to determine eligibility for unattended property viewing. In some embodiments, the seller may remotely manage property showings and may receive follow-up information associated with viewing activities.

In some embodiments, the process may continue to step 1508, which may correspond to an offer evaluation stage. In some embodiments, after a buyer submits an offer for the property, the platform may provide consultation or guidance associated with evaluating the offer. The consultation may assist the seller in reviewing proposed transaction parameters, negotiating conditions, and generating documentation required to reach mutual acceptance of terms between transaction participants.

In some embodiments, the process may proceed to step 1510, which may correspond to an inspection stage. In some embodiments, an in-person inspection of the property may be conducted to evaluate property condition. Inspection findings may be used to inform negotiation adjustments, remedial agreements, or confirmation of property readiness for transaction progression.

In some embodiments, the process may continue to step 1512, which may correspond to an appraisal stage. In some embodiments, a lender or financial institution may conduct a property appraisal to determine whether the proposed sale price aligns with an estimated market value. In some embodiments, the appraisal stage may support comparison of property valuation data and may assist in resolving valuation discrepancies that may arise during financing review.

In some embodiments, the process may proceed to step 1514, which may correspond to an escrow signing stage. In some embodiments, documentation required for closing may be prepared and executed through an escrow process. This stage may include signing documentation associated with transfer of ownership and completion of legal transaction formalities.

In some embodiments, the process may conclude with step 1516, which may correspond to a transaction completion stage. In some embodiments, completion of the closing process may finalize the sale of the property and transfer of ownership to the buyer. The platform may update transaction status records to indicate successful completion of the sale.

Accordingly, FIG. 15 illustrates an example sequence of operational stages associated with managing a property transaction through a real estate platform, where each stage may be performed independently or in combination with other stages depending on transaction conditions and platform configuration.

In some embodiments, the invention may provide a verification-gated remote property access control architecture that may improve the technology of networked physical access control for real-estate showings. In some embodiments, a technical problem may arise because conventional listing platforms may merely publish listing information while access to a property may remain manually coordinated through telephone calls, text messages, or static lockbox codes, thereby creating latency, weak auditability, poor synchronization between identity verification state and access state, and a heightened risk of unauthorized entry. In some embodiments, the disclosed platform may improve this technology by generating a machine-readable showing authorization data only after a buyer verification data has been analyzed and a verification status has been determined, such that digital access entitlement may be computationally tied to a specific property listing data and to a specific verified buyer state. In some embodiments, the platform may implement this feature by maintaining a server-side authorization record that may encode a property identifier, a buyer identifier, a validity interval, a showing condition, and an access status, and the authorization record may be transmitted to a seller device or another network-accessible endpoint for controlled use. In some embodiments, the authorization record may be implemented as a time-bounded token, a revocable access object, an encrypted payload, a signed authorization message, or a stateful database entry queried at access time. In some embodiments, the platform may further improve access-control technology by causing authorization issuance to depend on completion of background verification, identity verification, or proof-of-funds verification, thereby reducing decoupling between trust assessment and access grant. In some embodiments, the technical effect may include more deterministic access governance, lower risk of stale or duplicated authorization data, improved traceability of access events, and reduced manual coordination overhead in a distributed showing environment.

In some embodiments, the invention may provide an integrated buyer-verification processing pipeline that may improve the technology of online identity and eligibility verification in a real-estate transaction workflow. In some embodiments, a technical problem may arise because a buyer may otherwise be screened through fragmented workflows in which identity artifacts, financing artifacts, and communication artifacts may be handled across disconnected systems, thereby producing inconsistent verification states, redundant data entry, and poor transaction-state continuity. In some embodiments, the platform may address this problem by receiving a buyer verification data, extracting one or more identity attribute data therefrom, comparing the extracted data with a verification reference data, and determining a buyer verification status or a background verification status that may be reused in later transaction stages. In some embodiments, the buyer verification data may include an identification image, a structured identity record, a proof-of-funds record, an address record, a financial preapproval artifact, a screening result, or any combination thereof. In some embodiments, the verification reference data may include a trusted template, a rule set, a validation schema, a cryptographic signature set, or an externally obtained verification result already normalized into an internal platform format. In some embodiments, the platform may implement the verification pipeline by using deterministic rule evaluation, confidence-scored matching, field-level normalization, checksum validation, document classification, or anomaly scoring, and may store intermediate and final verification outputs for later authorization decisions. In some embodiments, the technology being improved may be identity-verification workflow orchestration for network transaction systems, and the technical effect may include lower verification latency, better consistency of verification outcomes, reduced failure caused by schema mismatch, and improved reuse of verification outputs across access control, offer handling, and closing preparation stages.

In some embodiments, the invention may provide a remotely managed showing orchestration engine that may improve the technology of distributed scheduling and event coordination for property access sessions. In some embodiments, a technical problem may arise because a property showing may involve asynchronous constraints relating to seller availability, buyer verification status, property readiness, and security monitoring availability, and conventional scheduling tools may not natively resolve such constraints within a listing-specific control plane. In some embodiments, the platform may determine a showing availability parameter based on a property listing data and may generate a showing schedule data that may be transmitted to a seller device, stored, and further associated with a verified access authorization. In some embodiments, the showing availability parameter may include a time window, occupancy condition, geographic condition, listing state, access policy, seller preference, or verification threshold. In some embodiments, the scheduling engine may implement conflict detection, time-slot pruning, rule-based prioritization, sequential authorization issuance, automatic expiration of unused slots, and synchronization between showing schedule state and verification state. In some embodiments, the scheduling engine may generate a canonical session object for each showing, and the session object may include a schedule identifier, a participant identity reference, a property identifier, a start condition, an end condition, and a monitoring policy. In some embodiments, the technology being improved may be server-based appointment orchestration in a security-sensitive environment, and the technical effect may include fewer conflicting reservations, lower administrative burden, stronger coupling between schedule state and security state, and more reliable remote showing execution.

In some embodiments, the invention may provide an integrated property monitoring and showing activity derivation pipeline that may improve the technology of event-aware remote observation for unattended property access. In some embodiments, a technical problem may arise because, in unattended showings, raw monitoring feeds may be voluminous, difficult to correlate with a scheduled showing, and insufficiently structured for later review or anomaly detection. In some embodiments, the platform may receive a property monitoring data from a camera device associated with a property, may analyze the property monitoring data to determine a showing activity data, and may generate a monitoring event data based on the showing activity data. In some embodiments, the property monitoring data may include image frames, video segments, timestamps, motion metadata, device status data, or communication heartbeat data. In some embodiments, the showing activity data may identify presence onset, entry occurrence, exit occurrence, dwell interval, abnormal pause, out-of-window access, or monitoring interruption. In some embodiments, the platform may implement the analysis by event segmentation, timestamp correlation with a scheduled showing interval, motion-boundary detection, frame differencing, occupancy estimation, metadata clustering, or rule-based abnormality detection. In some embodiments, the generated monitoring event data may be stored as compact event records rather than as only raw media, thereby reducing review complexity and improving later audit processing. In some embodiments, the technology being improved may be network video event abstraction and session correlation, and the technical effect may include improved forensic readability, lower bandwidth consumption for review tasks, more precise detection of deviations from authorized showing parameters, and more efficient downstream security analytics.

In some embodiments, the invention may provide a property imaging and virtual-tour generation workflow that may improve the technology of remote property visualization in listing systems. In some embodiments, a technical problem may arise because conventional static listing media may provide fragmented visual context, may require a large number of manually organized image assets, and may not adequately support remote evaluation of interior continuity and spatial relation. In some embodiments, the platform may receive a property imaging data from a property imaging system, may process the property imaging data to generate a virtual tour data, may store the virtual tour data, and may transmit the virtual tour data to a seller device or another authorized endpoint. In some embodiments, the property imaging data may include panoramic captures, sequential room images, depth-enhanced captures, metadata describing camera pose, or structured image ordering data. In some embodiments, the virtual tour data may be implemented as a linked scene graph, a stitched panoramic sequence, a navigable room-transition model, a tiled streaming asset, or another machine-consumable visualization package. In some embodiments, the processing may include image normalization, seam alignment, scene ordering, compression optimization, transition mapping, and generation of metadata describing navigable relationships among views. In some embodiments, the technology being improved may be digital property visualization and network delivery of immersive listing content, and the technical effect may include higher fidelity remote inspection, reduced ambiguity in spatial understanding, fewer unnecessary in-person visits, and more efficient delivery of large media objects through structured virtual-tour packaging.

In some embodiments, the invention may provide an offer-analysis and contract-preparation data pipeline that may improve the technology of structured transaction-document generation. In some embodiments, a technical problem may arise because offer terms may arrive in heterogeneous formats and may need to be manually transcribed into agreement-related artifacts, which may increase inconsistency, delay, and transcription error. In some embodiments, the platform may receive an offer data associated with a property listing data, may analyze the offer data to determine a transaction parameter data, and may generate a contract preparation data based on the transaction parameter data. In some embodiments, the transaction parameter data may include offer price, contingency indicator, timing parameter, financing condition, inspection condition, or acceptance window. In some embodiments, the platform may normalize unstructured or semi-structured offer inputs into a canonical transaction schema, may perform completeness checking, may detect incompatible term combinations, and may generate a machine-processable contract preparation output for downstream execution. In some embodiments, the contract preparation data may be a field-mapped template object, a parameterized agreement draft, a structured clause package, or a document-generation input record. In some embodiments, the technology being improved may be automated legal-document parameterization in server-based transaction systems, and the technical effect may include reduced manual data translation, improved term consistency, lower document-generation error, and more deterministic transition from offer receipt to agreement preparation.

In some embodiments, the invention may provide an inspection-result ingestion and condition-assessment pipeline that may improve the technology of condition-aware transaction progression. In some embodiments, a technical problem may arise because inspection results may be generated outside the listing platform and may otherwise remain disconnected from negotiation and transaction state, thereby forcing repeated manual review and increasing the likelihood that condition findings may not be operationally reflected in later stages. In some embodiments, the platform may receive an inspection data associated with a property from an inspection system, may analyze the inspection data to determine a property condition parameter, and may generate an inspection assessment data based on the property condition parameter. In some embodiments, the inspection data may be structured, semi-structured, or document-derived, and may include issue severity indicators, location indicators, remediation notes, or pass-fail markers. In some embodiments, the property condition parameter may include a summarized issue class, a severity score, a negotiation relevance indicator, or a repair-impact indicator. In some embodiments, the platform may implement the analysis by field extraction, rule-based classification, severity normalization, issue deduplication, and linkage of findings to transaction milestones. In some embodiments, the technology being improved may be inspection-data normalization and workflow coupling, and the technical effect may include faster condition interpretation, more reliable negotiation support, and improved interoperability between inspection information and transaction management state.

In some embodiments, the invention may provide an appraisal comparison engine that may improve the technology of valuation-data reconciliation. In some embodiments, a technical problem may arise because market valuation inputs may be generated from lender-side processes and may need to be compared with listing-side pricing data, yet conventional systems may not preserve a machine-readable comparison layer that may drive later transaction decisions. In some embodiments, the platform may receive an appraisal data associated with a property from a lender system, may analyze the appraisal data to determine a market valuation parameter, and may compute a valuation comparison data between the market valuation parameter and the property listing data. In some embodiments, the appraisal data may include a numeric estimate, a value range, supporting factor data, adjustment data, or confidence metadata. In some embodiments, the valuation comparison data may include a variance value, a threshold-exceedance flag, an alignment score, or a pricing adjustment suggestion record. In some embodiments, the computation may use deterministic difference calculation, weighted factor alignment, confidence-aware reconciliation, or threshold-based exception generation. In some embodiments, the technology being improved may be automated valuation comparison in online transaction platforms, and the technical effect may include faster pricing discrepancy detection, reduced manual reconciliation effort, and more reliable propagation of value-related issues into the transaction workflow.

In some embodiments, the invention may provide a title-authorization and closing-readiness generation pipeline that may improve the technology of closing-state synchronization. In some embodiments, a technical problem may arise because title state, escrow state, and closing readiness may otherwise be tracked in loosely coupled communications that may not be programmatically mapped into a unified transaction state. In some embodiments, the platform may receive a title authorization data from a title system, may analyze the title authorization data to determine a title verification parameter, and may generate a closing authorization data based on the title verification parameter. In some embodiments, the title verification parameter may identify clearance status, deficiency state, document-completeness state, or transfer-readiness state. In some embodiments, the closing authorization data may be implemented as a closing-state object, a readiness token, an authorization record, or a transaction-finalization flag set. In some embodiments, the platform may use status mapping logic, dependency resolution, and rule-based state advancement to ensure that only title states satisfying predefined conditions may result in closing authorization output. In some embodiments, the technology being improved may be server-side closing workflow coordination, and the technical effect may include reduced ambiguity in closing readiness, lower risk of premature finalization, and improved synchronization between title-related data and transaction execution state.

In some embodiments, the invention may provide an integrated financing-estimation and payment-projection engine that may improve the technology of listing-associated financing analytics. In some embodiments, a technical problem may arise because payment estimation may otherwise be performed in disconnected calculators that may not be synchronized with the active listing context, thereby causing repeated data entry and reduced continuity between property evaluation and financing evaluation. In some embodiments, the platform may receive a financing parameter data from a financing system, may analyze the financing parameter data to determine a mortgage estimation data, and may generate a payment projection data based on the mortgage estimation data. In some embodiments, the financing parameter data may include rate data, term data, cost data, tax data, or insurance-related data. In some embodiments, the payment projection data may include periodic payment amount, estimated closing cost amount, affordability indicator, or scenario comparison output. In some embodiments, the platform may implement the analysis by parameter normalization, scenario instantiation, amortization computation, cost aggregation, and projection caching for repeated listing-specific use. In some embodiments, the technology being improved may be integrated mortgage computation and listing-context analytics, and the technical effect may include lower input redundancy, more consistent property-specific financing estimates, and improved computational continuity between listing interaction and financing evaluation.

In some embodiments, the invention may further include a cryptographically bound dynamic access-token framework that may improve the technology of secure network authorization for remote property entry. In some embodiments, a technical problem may arise because fixed codes, reusable links, or static authorization records may be intercepted, replayed, or reused outside an authorized time interval. In some embodiments, the platform may therefore generate a short-lived access token that may be cryptographically bound to a property identifier, a verified buyer identifier, a scheduled showing interval, and a device-session identifier, and the token may be validated only within a permitted context. In some embodiments, the token may be implemented as a signed token, an encrypted token, a nonce-bound message, a one-time challenge-response artifact, or a rolling authorization sequence. In some embodiments, the server may maintain a revocation ledger, a replay-detection cache, or an issuance counter so that token duplication or out-of-order token use may be detected. In some embodiments, the server may rotate keys, may expire tokens after a short interval, may bind token validation to geofenced network context, or may require proof of possession of a device-held secret. In some embodiments, the specific technology being improved may be cryptographic authorization control for physical-digital access convergence, and the technical effect may include resistance to replay attacks, stronger session integrity, narrower authorization scope, and more secure remote property access control.

In some embodiments, the invention may further include a privacy-preserving identity-verification subsystem that may improve the technology of identity proofing and regulated data handling. In some embodiments, a technical problem may arise because conventional verification systems may retain full copies of identity artifacts, thereby increasing data exposure, storage burden, and compliance complexity. In some embodiments, the platform may transform an identity record into a minimized verification artifact that may include only a derived verification status, a confidence metric, and a hashed or tokenized reference, while full source material may be transiently processed and then discarded or segregated. In some embodiments, the platform may implement this feature by field-level tokenization, secure enclave processing, zero-retention extraction, selective redaction, template hashing, or compartmentalized storage of verification metadata separate from source content. In some embodiments, the subsystem may support document verification, liveness-backed identity proofing, reusable verifiable credentials, or issuer-signed attestations. In some embodiments, the subsystem may generate a compact verification certificate that may be reused across multiple showings for the same buyer without re-exposing full identity content. In some embodiments, the specific technology being improved may be privacy-aware digital identity infrastructure, and the technical effect may include reduced sensitive-data persistence, lower attack surface, faster repeated verification, and improved server-side management of identity-related artifacts.

In some embodiments, the invention may further include a graph-based showing-risk analysis engine that may improve the technology of anomaly detection in access-controlled transaction platforms. In some embodiments, a technical problem may arise because risk may not be adequately represented by isolated buyer attributes alone, and suspicious behavior may emerge from relationships among buyer identity state, device state, showing history, property state, and authorization pattern. In some embodiments, the platform may build a graph structure in which nodes may represent buyers, properties, devices, authorization records, schedule windows, and monitoring events, and edges may represent interactions, temporal co-occurrence, reuse patterns, or verification dependencies. In some embodiments, the processing device may compute a risk score, a cluster anomaly indicator, or a trust-propagation value across the graph to determine whether a requested showing or an active authorization may exhibit abnormal behavior. In some embodiments, the graph analysis may use rule-based subgraph detection, temporal motif analysis, neighborhood consistency checks, or learned embeddings derived from prior event structures. In some embodiments, examples may include detection of repeated short-interval authorization requests across geographically inconsistent properties, reuse of a device identity across multiple unrelated buyer identities, or a mismatch between monitoring event timing and authorized session topology. In some embodiments, the specific technology being improved may be graph-based event security analysis for distributed access systems, and the technical effect may include earlier detection of coordinated misuse, improved discrimination between normal and abnormal showing patterns, and more robust server-side protection of unattended properties.

In some embodiments, the invention may further include an edge-assisted media summarization and selective upload architecture that may improve the technology of remote property monitoring and media transport efficiency. In some embodiments, a technical problem may arise because continuous upload of raw monitoring media from a property may consume excessive bandwidth, may increase storage cost, and may degrade practical scalability for unattended showing supervision. In some embodiments, the system may therefore cooperate with a camera-side or gateway-side component configured to pre-segment motion intervals, extract event metadata, or compute compact scene descriptors, while the server may receive summarized event packages and may selectively request high-resolution source segments only for intervals associated with a verified showing or a suspected anomaly. In some embodiments, the server-side platform may store event-index records, may correlate the records with a showing session, and may trigger deferred retrieval of source media upon detection of a rule violation. In some embodiments, examples may include uploading only entry, exit, or prolonged-dwell segments; uploading low-resolution proxy media first and high-resolution media on demand; or uploading event vectors and timestamps while retaining bulk media locally until requested. In some embodiments, the specific technology being improved may be network video transport and event-centric media management, and the technical effect may include reduced upstream bandwidth usage, lower storage overhead, faster event review, and improved scalability of property monitoring across a large inventory of listings.

In some embodiments, the invention may further include a multimodal property-state reconstruction engine that may improve the technology of virtual property representation. In some embodiments, a technical problem may arise because conventional virtual tours may rely on manually ordered image sets that may not adequately capture room adjacency, depth continuity, or spatial change over time. In some embodiments, the platform may ingest image data, panoramic data, and optionally depth-associated metadata, and may generate a structured spatial representation of the property in the form of a scene graph, a room adjacency model, or a lightweight digital twin. In some embodiments, the reconstruction engine may perform image feature matching, camera-pose estimation, room-boundary inference, spatial consistency checks, and topology generation so that navigation through the virtual representation may correspond more closely to the actual structure of the property. In some embodiments, the engine may also maintain versioned property-state models so that modifications, staging changes, or condition changes may be reflected in successive digital representations. In some embodiments, examples may include a stitched walk-through model, a room-linked panorama map, or a depth-aware spatial skeleton used to align different imaging sessions. In some embodiments, the specific technology being improved may be spatial media reconstruction and remote environment representation, and the technical effect may include greater navigational realism, improved remote inspection fidelity, and better computational reuse of property-imaging assets across listing, showing, and condition-assessment workflows.

In some embodiments, the invention may further include a retrieval-augmented transaction guidance engine that may improve the technology of context-aware workflow assistance within the platform. In some embodiments, a technical problem may arise because platform users may receive generic guidance that is not synchronized with the current transaction state, verification status, inspection state, or jurisdiction-specific document condition, thereby increasing operational error and support burden. In some embodiments, the platform may maintain a structured repository of workflow rules, explanatory content, transaction templates, and state-conditioned guidance objects, and may retrieve contextually relevant guidance based on a current property listing state, buyer verification state, offer state, or closing state. In some embodiments, the guidance engine may use semantic retrieval, metadata filtering, state-conditioned ranking, and template parameter injection to generate a guidance output that may be specific to a current session without requiring manual navigation across static help content. In some embodiments, examples may include retrieval of seller guidance responsive to an appraisal mismatch, retrieval of contract-preparation guidance conditioned on a financing contingency, or retrieval of showing instructions conditioned on an unattended access mode. In some embodiments, the specific technology being improved may be server-side workflow assistance and knowledge retrieval in transaction systems, and the technical effect may include lower support latency, improved procedural consistency, and more precise alignment of guidance content with machine-detected transaction context.

In some embodiments, the invention may further include a tamper-evident transaction event ledger that may improve the technology of audit logging and evidentiary integrity in SaaS transaction platforms. In some embodiments, a technical problem may arise because conventional logs may be mutable, fragmented across services, or insufficiently linked to authorization, verification, and document-generation events, thereby weakening dispute analysis and operational traceability. In some embodiments, the platform may therefore generate an append-only event chain in which each event record may include a timestamp, an event type, a property identifier, a transaction identifier, and a cryptographic digest linked to a preceding event record. In some embodiments, the ledger may record verification completion, authorization issuance, monitoring anomaly detection, offer receipt, contract preparation, appraisal comparison, and closing authorization generation. In some embodiments, the ledger may be realized in a hash-chained database table, a merkleized event store, a write-once log segment architecture, or another tamper-evident persistence model. In some embodiments, the specific technology being improved may be evidentiary logging and transactional audit integrity, and the technical effect may include improved resistance to silent log alteration, better reconstruction of transaction chronology, and stronger technical support for security review and dispute resolution.

In some embodiments, any of the foregoing technical improvements may be combined so that a verified buyer identity state may control tokenized access issuance, monitoring event generation may feed a graph-based risk engine, imaging output may populate a spatial property model, and a tamper-evident ledger may preserve the lifecycle of each state transition. In some embodiments, such combinations may further improve the underlying technologies of identity verification, authorization control, networked monitoring, immersive property visualization, workflow orchestration, and transaction-state integrity within the disclosed real-estate platform.

Although the invention has been explained in relation to its preferred embodiment, it is to be understood that many other possible modifications and variations can be made without departing from the spirit and scope of the invention as hereinafter claimed.

1. A method of facilitating controlled remote property access authorization through a software-as-a-service real estate transaction platform, the method comprising:
receiving, using a communication device, a property listing data associated with a property from a seller device;
receiving, using the communication device, a buyer verification data comprising an identity verification parameter from a buyer device;
storing, using a storage device, each of the property listing data and the buyer verification data;
analyzing, using a processing device, the buyer verification data to determine a buyer verification status;
generating, using the processing device, a showing authorization data representing a verified access authorization for the property based on the property listing data and the buyer verification status;
storing, using the storage device, the showing authorization data; and
transmitting, using the communication device, the showing authorization data to the seller device.

2. The method of claim 1, further comprising:
receiving, using the communication device, a seller training request data from the seller device;
generating, using the processing device, a demonstration guidance data based on the property listing data;
storing, using the storage device, the demonstration guidance data; and
transmitting, using the communication device, the demonstration guidance data to the seller device.

3. The method of claim 1, further comprising:
receiving, using the communication device, a property monitoring data from a camera device associated with the property;
analyzing, using the processing device, the property monitoring data to determine a showing activity data;
generating, using the processing device, a monitoring event data based on the showing activity data; and
storing, using the storage device, the monitoring event data.

4. The method of claim 1, further comprising:
determining, using the processing device, a showing availability parameter based on the property listing data;
generating, using the processing device, a showing schedule data based on the showing availability parameter;
storing, using the storage device, the showing schedule data; and
transmitting, using the communication device, the showing schedule data to the seller device.

5. The method of claim 1, wherein analyzing the buyer verification data comprises:
extracting, using the processing device, an identity attribute data from the buyer verification data;
comparing, using the processing device, the identity attribute data with a verification reference data stored in the storage device;
determining, using the processing device, a background verification status based on the comparing; and
storing, using the storage device, the background verification status.

6. The method of claim 1, further comprising:
receiving, using the communication device, an offer data associated with the property listing data from the buyer device;
analyzing, using the processing device, the offer data to determine a transaction parameter data;
generating, using the processing device, a contract preparation data based on the transaction parameter data;
storing, using the storage device, the contract preparation data; and
transmitting, using the communication device, the contract preparation data to the seller device.

7. The method of claim 1, further comprising:
receiving, using the communication device, an inspection data associated with the property from an inspection system;
analyzing, using the processing device, the inspection data to determine a property condition parameter;
generating, using the processing device, an inspection assessment data based on the property condition parameter; and
storing, using the storage device, the inspection assessment data.

8. The method of claim 1, further comprising:
receiving, using the communication device, an appraisal data associated with the property from a lender system;
analyzing, using the processing device, the appraisal data to determine a market valuation parameter;
computing, using the processing device, a valuation comparison data between the market valuation parameter and the property listing data; and
storing, using the storage device, the valuation comparison data.

9. The method of claim 1, further comprising:
receiving, using the communication device, a title authorization data from a title system;
analyzing, using the processing device, the title authorization data to determine a title verification parameter;
generating, using the processing device, a closing authorization data based on the title verification parameter; and
storing, using the storage device, the closing authorization data.

10. The method of claim 1, further comprising:
receiving, using the communication device, a property imaging data from a property imaging system;
processing, using the processing device, the property imaging data to generate a virtual tour data;
storing, using the storage device, the virtual tour data; and
transmitting, using the communication device, the virtual tour data to the seller device.

11. A system for facilitating controlled remote property access authorization through a software-as-a-service real estate transaction platform, the system comprising:
a communication device configured for:
receiving a property listing data associated with a property from a seller device;
receiving a buyer verification data comprising an identity verification parameter from a buyer device; and
transmitting a showing authorization data to the seller device;
a processing device configured for:
analyzing the buyer verification data to determine a buyer verification status; and
generating the showing authorization data representing a verified access authorization for the property based on the property listing data and the buyer verification status; and
a storage device configured for storing each of the property listing data, the buyer verification data and the showing authorization data.

12. The system of claim 11, wherein the communication device is further configured for:
receiving a seller training request data from the seller device; and
transmitting a demonstration guidance data to the seller device, wherein the processing device is further configured for generating the demonstration guidance data based on the property listing data, wherein the storage device is further configured for storing the demonstration guidance data.

13. The system of claim 11, wherein the communication device is further configured for receiving a property monitoring data from a camera device associated with the property, wherein the processing device is further configured for:
analyzing the property monitoring data to determine a showing activity data; and
generating a monitoring event data based on the showing activity data, wherein the storage device is further configured for storing the monitoring event data.

14. The system of claim 11, wherein the processing device is further configured for:
determining a showing availability parameter based on the property listing data; and
generating a showing schedule data based on the showing availability parameter, wherein the storage device is further configured for storing the showing schedule data, wherein the communication device is further configured for transmitting the showing schedule data to the seller device.

15. The system of claim 11, wherein the processing device is further configured for:
extracting an identity attribute data from the buyer verification data;
comparing the identity attribute data with a verification reference data stored in the storage device; and
determining a background verification status based on the comparing, wherein the storage device is further configured for storing the background verification status.

16. The system of claim 11, wherein the communication device is further configured for receiving an offer data associated with the property listing data from the buyer device, wherein the processing device is further configured for:
analyzing the offer data to determine a transaction parameter data; and
generating a contract preparation data based on the transaction parameter data, wherein the storage device configured for storing the contract preparation data, wherein the communication device is further configured for transmitting the contract preparation data to the seller device.

17. The system of claim 11, wherein the communication device is further configured for receiving an inspection data associated with the property from an inspection system, wherein the processing device is further configured for:
analyzing the inspection data to determine a property condition parameter; and
generating an inspection assessment data based on the property condition parameter, wherein the storage device further configured for storing the inspection assessment data.

18. The system of claim 11, wherein the communication device is further configured for receiving an appraisal data associated with the property from a lender system, wherein the processing device is further configured for:
analyzing the appraisal data to determine a market valuation parameter; and
computing a valuation comparison data between the market valuation parameter and the property listing data, wherein the storage device is further configured for storing the valuation comparison data.

19. The system of claim 11, wherein the communication device is further configured for receiving a title authorization data from a title system, wherein the processing device is further configured for:
analyzing the title authorization data to determine a title verification parameter; and
generating a closing authorization data based on the title verification parameter, wherein the storage device configured for storing the closing authorization data.

20. The system of claim 11, wherein the communication device is further configured for receiving a property imaging data from a property imaging system, wherein the processing device is further configured for processing the property imaging data to generate a virtual tour data, wherein the storage device is further configured for storing the virtual tour data, wherein the communication device is further configured for transmitting the virtual tour data to the seller device.
